(19) United States
(12) Patent Application Publication
(10) Pub. No.: US 2025/0257169 A1
(43) Pub. Date: Aug. 14, 2025

(54) COMPOSITION, URETHANE PREPOLYMER, AND RELATED METHODS AND USES

(71) Applicants: DOW SILICONES CORPORATION, Midland, MI (US); DOW GLOBAL TECHNOLOGIES LLC, Midland, MI (US)

(72) Inventors: Elizabeth DHULST, Collegeville, PA (US); Edward NYUTU, Midland, MI (US); Krishnaja DUVVURI, Midland, MI (US); Michael TULCHINSKY, Midland, MI (US); Adam GRZESIAK, Midland, MI (US); Mihee KIM, Midland, MI (US); Stephanie HUGHES, Midland, MI (US); Qichun WAN, Midland, MI (US); Haoquan LI, Midland, MI (US); Bindu KRISHNAN, Lake Jackson, TX (US)

(21) Appl. No.: 18/856,547

(22) PCT Filed: Apr. 7, 2023
(86) PCT No.: PCT/US2023/017886

§ 371 Date: Oct. 11, 2024

Related U.S. Application Data
(60) Provisional application No. 63/330,517, filed on Apr. 13, 2022.

(51) Int. Cl. C08G 18/61; C08G 18/12; C08G 18/48; C08G 18/76; C08G 77/38; C08G 77/46

(52) U.S. Cl. CPC C08G 18/61; C08G 18/12; C08G 18/4812; C08G 18/7671; C08G 77/38; C08G 77/46

(57) ABSTRACT

A composition comprises (A) a carbinol-functional siloxane; and (B) a polyisocyanate. The carbinol-functional siloxane (A) is not prepared via a hydrosilylation reaction. In addition, the composition comprises less than 5 mole % of (C) compounds of formula R—Oₐ—(C_{b}H_{2b}O)_{c}—R¹, where R is an ethylenically unsaturated group, R¹ is H or a hydrocarbyl group, subscript a is 0 or 1, subscript b is independently selected from 2 to 4 in each moiety indicated by subscript c, and subscript c is from 0 to 500, with the proviso that subscripts a and c are not simultaneously 0. A urethane prepolymer comprising the reaction product of the composition is also disclosed.

### CROSS REFERENCE TO RELATED APPLICATIONS

This application claims priority to and all advantages of U.S. Provisional Patent Application No. 63/330,517 filed on 13 Apr. 2022, the content of which is incorporated herein by reference.

### TECHNICAL FIELD

The subject disclosure generally relates to a composition and, more specifically, to composition for preparing a urethane prepolymer, methods associated therewith, and end uses of the same.

### BACKGROUND

Carbinol-functional siloxanes are known in the art and utilized in various end use applications, including in curable compositions, e.g. sealants, adhesives, etc. Conventional carbinol-functional siloxanes are prepared via hydrosilylation reactions, whereby an organopolysiloxane having silicon-bonded hydrogen atoms is hydrosilylated with an alcohol or a polyether having one terminal unsaturated group in the presence of a hydrosilylation catalyst. To ensure no residual silicon-bonded hydrogen atoms remain, and to account for isomerization of the terminal unsaturated group of the alcohol or polyether, which reduces reactivity for hydrosilylation, a molar excess alcohol and/or polyether is generally utilized. As a result, conventional carbinol-functional siloxanes are generally utilized as a reaction product including both the conventional carbinol-functional siloxanes but also residual amounts of the alcohol and/or polyether (or isomerized version thereof), which can often constitute around 30 mol % of the reaction product. Said differently, residual alcohols and/or polyethers are inherently present along with conventional carbinol-functional siloxanes prepared via hydrosilylation. Because boiling point temperatures of conventional carbinol-functional siloxanes and such alcohols or polyethers are similar, particularly when the conventional carbinol-functional siloxanes are linear and have a small degree of polymerization, it's difficult and impractical to purify conventional carbinol-functional siloxanes by removing the residual amount of the alcohol and/or polyether from the reaction product, e.g. via distillation or stripping. The residual amounts of alcohol and/or polyether cause undesirable byproducts and side reactions when conventional carbinol-functional siloxanes are utilized, e.g. in a further reaction. The presence of the residual amounts of alcohol and/or polyether can have significant and undesirable impacts, particularly with regard to preparing prepolymers with conventional carbinol-functional siloxanes.

### BRIEF SUMMARY

A composition is disclosed, which comprises (A) a carbinol-functional siloxane; and (B) a polyisocyanate. The carbinol-functional siloxane (A) is not prepared via a hydrosilylation reaction. In addition, the composition comprises less than 5 mole % of (C) compounds of formula R—Oₐ—(C_{b}H_{2b}O)_{c}—R¹, where R is an ethylenically unsaturated group, R¹ is H or a hydrocarbyl group, subscript a is 0 or 1, subscript b is independently selected from 2 to 4 in each moiety indicated by subscript c, and subscript c is from 0 to 500, with the proviso that subscripts a and c are not simultaneously 0.

A urethane prepolymer comprising the reaction product of the composition is also disclosed. Further, cured products of the composition and the urethane prepolymer, respectively, are also disclosed.

In addition, a method of preparing the composition is disclosed. The method comprises combining the (A) carbinol-functional siloxane and (B) polyisocyanate.

### DESCRIPTION OF THE DRAWINGS

Various advantages and aspects of this disclosure may be understood in view of the following detailed description when considered in connection with the accompanying drawings, wherein:

FIG. 1 shows RI signal as a function of elution time for a Polyether-functional Siloxane and a Comparative Polyether-functional Siloxane composition from the Examples of this disclosure; and

FIG. 2 shows RI signal as a function of elution time for the isocyanate-functional prepolymers of Example 1 and Comparative Example 1, respectively.

### DETAILED DESCRIPTION OF THE INVENTION

A composition is disclosed. The composition is particularly suited for preparing urethane prepolymers, which are also disclosed, along with methods of their preparation and use.

The composition comprises (A) a carbinol-functional siloxane and (B) a polyisocyanate. In certain embodiments, the (A) carbinol-functional siloxane has an average of at least two carbinol-functional groups per molecule. In these embodiments, the carbinol-functional groups can be the same as or different from one another. Carbinol-functional groups on organopolysiloxanes are distinguished from silanol groups, where carbinol-functional groups include a carbon-bonded hydroxyl group, and silanol functional groups include a silicon-bonded hydroxyl group. Said differently, carbinol-functional groups are of formula —COH, whereas silanol functional groups are of formula —SiOH. These functional groups perform differently; for example, silanol functional groups can readily condense to give siloxane (—Si—O—Si—) bonds, which generally does not occur with carbinol-functional groups (at least under the same catalysis of hydrolysis of silanol functional groups).

In certain embodiments, the carbinol-functional groups independently have the general formula -D-Oₐ—(C_{b}H_{2b}O)_{c}—H, where D is a covalent bond or a divalent hydrocarbon linking group having from 2 to 18 carbon atoms, subscript a is 0 or 1, subscript b is independently selected from 2 to 4 in each moiety indicated by subscript c, and subscript c is from 0 to 500, with the proviso that subscripts a and c are not simultaneously 0.

In one embodiment, subscript c is at least one such that at least one of the carbinol-functional groups has the general formula:

-D-Oₐ—[C₂H₄O]ₓ[C₃H₆O]_{y}[C₄H₈O]_{z}—H;

where D is a covalent bond or a divalent hydrocarbon linking group having from 2 to 18 carbon atoms, subscript a is 0 or 1, 0≤x≤500, 0≤y≤500, and 0≤z≤500, with the proviso that 1≤x+y+z≤500. In these embodiments, the carbinol-functional group may alternatively be referred to as a polyether group or moiety, although the polyether group or moiety terminates with —COH, rather than —COR⁰, where R⁰ is a monovalent hydrocarbon group. As understood in the art, moieties indicated by subscript x are ethylene oxide (EO) units, moieties indicated by subscript y are propylene oxide (PO) units, and moieties indicated by subscript z are butylene oxide (BO) units. The EO, PO, and BO units, if present, may be in block or randomized form in the polyether group or moiety. The relative amounts of EO, PO, and BO units, if present, can be selectively controlled based on desired properties of the (A) carbinol-functional siloxane, composition, and resulting polyurethane article. For example, the molar ratios of such alkylene oxide units can influence hydrophilicity and other properties.

In another embodiment, subscript c is 0 and subscript a is 1 such that at least one of the carbinol-functional groups has the general formula: -D-OH, where D is described above. In these embodiments, the carbinol-functional groups having this general formula are not polyether groups or moieties.

Regardless of the independent selection of the carbinol-functional groups of component (A), component (A) is typically substantially linear. By substantially linear, it is meant that component (A) comprises, consists essentially of, or consists of only M and D siloxy units. As readily understood in the art, M siloxy units are of formula [R²₃SiO_{1/2}] and D siloxy units are of formula [R²₂SiO_{2/2}]. Traditionally, M and D siloxy nomenclature is utilized in connection with only methyl substitution. However, for purposes of this disclosure, in the M and D siloxy units above, each R² is independently selected from substituted or unsubstituted hydrocarbyl groups or carbinol-functional groups, with the proviso that at least one R² is a carbinol-functional group. When an M siloxy unit includes at least one carbinol-functional group, the carbinol-functional group is terminal. When a D siloxy unit includes at least one carbinol-functional group, the carbinol-functional group is pendent. The substantially linear organopolysiloxane may have the average formula: R²_{a′}SiO_{(4-a′)/2}, where each R² is independently selected and defined above, including the proviso that at least one R² is a carbinol-functional group, and where subscript a′ is selected such that 1.9≤a′≤2.2.

In general, hydrocarbyl groups suitable for R² may independently be linear, branched, cyclic, or combinations thereof. Cyclic hydrocarbyl groups encompass aryl groups as well as saturated or non-conjugated cyclic groups. Cyclic hydrocarbyl groups may independently be monocyclic or polycyclic. Linear and branched hydrocarbyl groups may independently be saturated or unsaturated. One example of a combination of a linear and cyclic hydrocarbyl group is an aralkyl group. General examples of hydrocarbyl groups include alkyl groups, aryl groups, alkenyl groups, halocarbon groups, and the like, as well as derivatives, modifications, and combinations thereof. Examples of suitable alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, hexadecyl, octadecyl, as well as branched saturated hydrocarbon groups having from 6 to 18 carbon atoms. Examples of suitable non-conjugated cyclic groups include cyclobutyl, cyclohexyl, and cycyloheptyl groups. Examples of suitable aryl groups include phenyl, tolyl, xylyl, naphthyl, benzyl, and dimethyl phenyl. Examples of suitable alkenyl groups include vinyl, allyl, propenyl, isopropenyl, butenyl, isobutenyl, pentenyl, heptenyl, hexenyl, hexadecenyl, octadecenyl and cyclohexenyl groups. Examples of suitable monovalent halogenated hydrocarbon groups (i.e., halocarbon groups, or substituted hydrocarbon groups) include halogenated alkyl groups, aryl groups, and combinations thereof. Examples of halogenated alkyl groups include the alkyl groups described above where one or more hydrogen atoms is replaced with a halogen atom such as F or Cl. Specific examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, and 3,4-difluoro-5-methylcycloheptyl, chloromethyl, chloropropyl, 2-dichlorocyclopropyl, and 2,3-dichlorocyclopentyl groups, as well as derivatives thereof. Examples of halogenated aryl groups include the aryl groups described above where one or more hydrogen atoms is replaced with a halogen atom, such as F or Cl. Specific examples of halogenated aryl groups include chlorobenzyl and fluorobenzyl groups.

In specific embodiments, each R² that is not a carbinol-functional group is independently selected from alkyl groups having from 1 to 32, alternatively from 1 to 28, alternatively from 1 to 24, alternatively from 1 to 20, alternatively from 1 to 16, alternatively from 1 to 12, alternatively from 1 to 8, alternatively from 1 to 4, alternatively 1, carbon atoms.

In other embodiments, the (A) carbinol-functional siloxane may include at least some branching attributable to the presence of T or Q siloxy units. As understood in the art, T units are of formula [R²SiO_{3/2}] and Q siloxy units are of formula [SiO_{4/2}], where R² is defined above. However, the (A) carbinol-functional siloxane is typically free from such T and Q siloxy units. By “at least some,” it is meant that the (A) carbinol-functional siloxane may include up to 5, alternatively up to 4, alternatively up to 3, alternatively up to 2, alternatively up to 1, alternatively 0, mol % T and Q siloxy units based on all siloxy units present in the (A) carbinol-functional siloxane. If such branching is present in the (A) carbinol-functional siloxane, it is typically attributable to T siloxy units rather than Q siloxy units. Typically, in view of desired viscosities, the (A) carbinol-functional siloxane is a flowable liquid at room temperature, including in the absence of any solvent or carrier vehicle, rather than a gum or resin. While gums or resins can be liquid at room temperature when solubilized or dispersed in a solvent or carrier fluid, such solvents can be undesirable in certain end use applications, as solvents are typically volatilized or otherwise removed during a curing process.

In embodiments where component (A) is linear, component (A) may have the general formula:

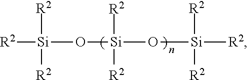

where each R² is an independently selected and defined above, including the proviso that at least one R² is a carbinol-functional group, and subscript n is from 0 to 100. Subscript n may alternatively be referred to as the degree of polymerization (DP) of component (A). Typically, DP is directly proportional to viscosity, all else (e.g. substituents and branching) being equal, i.e., increasing DP increases viscosity. Subscript n is alternatively from greater than 0 to 95, alternatively from greater than 0 to 90, alternatively from greater than 0 to 85, alternatively from greater than 0 to 80, alternatively from greater than 0 to 75, alternatively from greater than 0 to 70, alternatively from greater than 0 to 65. Alternatively, subscript n is from 5 to 70, alternatively from 10 to 65. In one specific embodiment, subscript n is from 5 to 30, alternatively from 10 to 20, alternatively from 12 to 20. In an alternative specific embodiment, subscript n is from 28 to 32, alternatively from 29 to 31, alternatively 30. In an alternative specific embodiment, subscript n is from 48 to 52, alternatively from 49 to 51, alternatively 50. In an alternative specific embodiment, subscript n is from 58 to 62, alternatively from 59 to 61, alternatively 60.

In specific embodiments, each carbinol-functional group has formula -D-OH, and the (A) carbinol-functional siloxane has the following general formula:

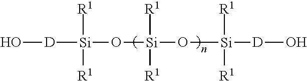

where D and subscript n are defined above, and where each R² is independently selected and defined above, but without the proviso requiring at least one R² being a carbinol-functional group given that the formula above includes two carbinol-functional groups. In these embodiments, the carbinol-functional groups are terminal in component (A). These carbinol-functional groups may be the same as or different from one another based on D. This formula can alternatively be written as [(HOD-)R²₂SiO_{1/2}]₂[Si²₂O_{2/2}]ₙ.

In other embodiments, each carbinol-functional group has the general formula -D-Oₐ—(C_{b}H_{2b}O)_{c}—H, where D and subscripts a-c are defined above, and the carbinol-functional groups are terminal such that the (A) carbinol-functional siloxane has the following general formula:

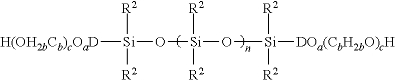

where each R² is independently selected and defined above, D and subscripts a-c and n are defined above. In a specific embodiment, component (A) has the following formula:

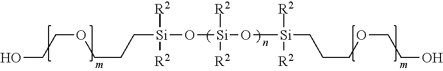

where each R² is independently selected and defined above, subscript n is from 0 to 100, and each of subscripts m is independently from 1 to 100. In this embodiment, n is typically from 0 to 80, alternatively from 0 to 60, alternatively from 0 to 50, alternatively from 0 to 40, alternatively from 5 to 35, alternatively from 5 to 30, alternatively from 5 to 25, alternatively from 10 to 20, and each m is from 1 to 50, alternatively from 1 to 40, alternatively from 1 to 30, alternatively from 2 to 20, alternatively from 5 to 10.

In other embodiments, each carbinol-functional group has the general formula -D-Oₐ—(C_{b}H_{2b}O)_{c}—H, where D and subscripts a-c are defined above, and the carbinol-functional groups are pendent such that the (A) carbinol-functional siloxane has the following general formula:

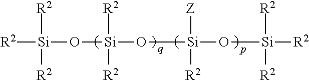

where each R² is independently selected and defined above, each subscript Z is -D-Oₐ—(C_{b}H_{2b}O)_{c}—H, where D and subscripts a-c are defined above, and subscripts p and q are each from 1 to 99, with the proviso that p+q≤100. In the general formula above, the siloxy units indicated by subscripts q and p may be randomized or in block form. The general formula above is intended to be a representation of the average unit formula of component (A) in this embodiment based on the number of R²₂SiO_{2/2} units indicated by subscript q and R²ZSiO_{2/2} units indicated by subscript p without requiring a particular order thereof. Thus, this general formula may be written alternatively as [(R²)₃SiO_{1/2}]₂[(R²)₂SiO_{2/2}]_{q}[(R²)ZSiO_{2/2}]ₚ, where subscripts q and p are defined above. In these embodiments, the carbinol-functional groups are polyether groups, and the polyether groups are pendent in component (A). When each R² is methyl, this embodiment of component (A) is trimethylsiloxy endblocked, and includes dimethylsiloxy units (indicated by subscript q).

While specific structures of component (A) are exemplified above, component (A) can include terminal polyether groups as the carbinol-functional group, or pendent carbinol-functional groups that are not polyether groups, or any combination of independently selected carbinol-functional groups.

In certain embodiments, component (A) has a capillary viscosity (kinematic viscosity via glass capillary) at 25° C. of from 1 to 1,000, alternatively from 1 to 900, alternatively from 10 to 700, alternatively from 10 to 600, mPa·s. Capillary viscosity can be measured in accordance with Dow Corning Corporate Test Method CTM0004 of 20 Jul. 1970. CTM0004 is known in the art and based on ASTM D445, IP 71. Typically, when component (A) has pendent polyether groups as the carbinol-functional groups, component (A) has a higher viscosity than when component (A) includes terminal carbinol-functional groups that are not polyether groups (as set forth in the exemplary structures above). For example, when component (A) includes pendent polyether groups, the capillary viscosity at 25° C. is typically from 200 to 900, alternatively from 300 to 800, alternatively from 400 to 700, alternatively from 500 to 600 mPa·s. In contrast, when component (A) includes only terminal carbinol-functional groups which are not polyether groups, component (A) may have a capillary viscosity at 25° C. of from greater than 0 to 250, alternatively from greater than 0 to 100, alternatively from greater than 0 to 75, alternatively from 10 to 75, alternatively from 25 to 75, mPa·s.

In these or other embodiments, component (A) may have an OH equivalent weight of from 100 to 2,000, alternatively from 200 to 1,750, alternatively from 300 to 1,500, alternatively from 400 to 1,200 g/mol. Methods of determining OH equivalent weight are known in the art based on functionality and molecular weight.

In certain embodiments, the composition comprises component (A) in an amount of from greater than 0 to 75, alternatively from 10 to 50, alternatively from 10 to 40, alternatively from 10 to 30, weight percent based on the total weight of the composition.

As introduced above, the composition further comprises (B) a polyisocyanate. As readily understood in the art, the (B) polyisocyanate has two or more isocyanate-functional groups, which can react with the carbinol-functional groups of the (A) carbinol-functional siloxane.

Suitable (B) polyisocyanates have two or more isocyanate functionalities, and include conventional aliphatic, cycloaliphatic, araliphatic and aromatic isocyanates. The (B) polyisocyanate may be selected from the group of diphenylmethane diisocyanates (“MDI”), polymeric diphenylmethane diisocyanates (“pMDI”), toluene diisocyanates (“TDI”), hexamethylene diisocyanates (“HDI”), dicyclohexylmethane diisocyanates (“HMDI”), isophorone diisocyanates (“IPDI”), cyclohexyl diisocyanates (“CHDI”), naphthalene diisocyanate (“NDI”), phenyl diisocyanate (“PDI”), and combinations thereof. In one embodiment, the (B) polyisocyanate is of the formula OCN—R—NCO, wherein R is a hydrocarbon moiety (e.g. a linear, cyclic and/or aromatic moiety). In this embodiment, the (B) polyisocyanate can include any number of carbon atoms, typically from 4 to 20 carbon atoms.

Specific examples of suitable (B) polyisocyanates include: alkylene diisocyanates with 4 to 12 carbons in the alkylene moiety, such as 1,12-dodecane diisocyanate, 2-ethyl-1,4-tetramethylene diisocyanate, 2-methyl-1,5-pentamethylene diisocyanate, 1,4-tetramethylene diisocyanate and 1,6-hexamethylene diisocyanate; cycloaliphatic diisocyanates, such as 1,3- and 1,4-cyclohexane diisocyanate as well as any mixtures of these isomers, 1-isocyanato-3,3,5-trimethyl-5-isocyanatomethylcyclohexane, 2,4- and 2,6-hexahydrotoluene diisocyanate as well as the corresponding isomeric mixtures, 4,4′-2,2′-, and 2,4′-dicyclohexylmethane diisocyanate as well as the corresponding isomeric mixtures; and aromatic diisocyanates and polyisocyanates, such as 2,4- and 2,6-toluene diisocyanate and the corresponding isomeric mixtures, 4,4′-, 2,4′-, and 2,2′-diphenylmethane diisocyanate and the corresponding isomeric mixtures, mixtures of 4,4′-, 2,4′-, and 2,2-diphenylmethane diisocyanates and polyphenylenepolymethylene polyisocyanates, as well as mixtures of MDI and toluene diisocyanate (TDI).

The (B) polyisocyanate may include modified multivalent isocyanates, i.e., products obtained by the partial chemical reaction of organic diisocyanates and/or polyisocyanates. Examples of suitable modified multivalent isocyanates include diisocyanates and/or polyisocyanates containing ester groups, urea groups, biuret groups, allophanate groups, carbodiimide groups, isocyanurate groups, and/or urethane groups. Specific examples of suitable modified multivalent isocyanates include organic polyisocyanates containing urethane groups and having an NCO content of 15 to 33.6 parts by weight based on the total weight, e.g. with low molecular weight diols, triols, dialkylene glycols, trialkylene glycols, or polyoxyalkylene glycols with a molecular weight of up to 6,000; modified 4,4′-diphenylmethane diisocyanate or 2,4- and 2,6-toluene diisocyanate, where examples of di- and polyoxyalkylene glycols that may be used individually or as mixtures include diethylene glycol, dipropylene glycol, polyoxyethylene glycol, polyoxypropylene glycol, polyoxyethylene glycol, polyoxypropylene glycol, and polyoxypropylene polyoxyethylene glycols or -triols. Prepolymers containing NCO groups with an NCO content of from 3.5 to 29 parts by weight based on the total weight of the (B) polyisocyanate and produced from the polyester polyols and/or polyether polyols; 4,4′-diphenylmethane diisocyanate, mixtures of 2,4′- and 4,4′-diphenylmethane diisocyanate, 2,4- and/or 2,6-toluene diisocyanates or polymeric MDI are also suitable. Furthermore, liquid polyisocyanates containing carbodiimide groups may also be suitable, e.g. based on 4,4′- and 2,4′- and/or 2,2′-diphenylmethane diisocyanate and/or 2,4′- and/or 2,6-toluene diisocyanate. The modified polyisocyanates may optionally be mixed together or mixed with unmodified organic polyisocyanates such as 2,4′- and 4,4′-diphenylmethane diisocyanate, polymeric MDI, 2,4′- and/or 2,6-toluene diisocyanate.

It is to be appreciated that the (B) polyisocyanate may include any combination of two or more polyisocyanates that are different from one another based on functionality, molecular weight, viscosity, or structure. In specific embodiments, the (B) polyisocyanate comprises, consists essentially of, or is, MDI, which may comprise any blend of its isomers.

The (B) polyisocyanate typically has a functionality of from 2.0 to 5.0, alternatively from 2.0 to 4.5, alternatively from 2.0 to 4.0, alternatively from 2.0 to 3.5.

In these or other embodiments, the (B) polyisocyanate has a content of NCO by weight of from 15 to 60, alternatively from 15 to 55, alternatively from 20 to 48.5, wt. %. Methods of determining content of NCO by weight are known in the art based on functionality and molecular weight of the particular isocyanate.

In certain embodiments, the composition comprises component (B) in an amount of from greater than 0 to 75, alternatively from 10 to 50, alternatively from 10 to 40, alternatively from 10 to 30, weight percent based on the total weight of the composition.

The (A) carbinol-functional siloxane is not prepared via a hydrosilylation reaction. In addition, the composition comprises less than 5, alternatively less than 4.5, alternatively less than 4, alternatively less than 3.5, alternatively less than 3, alternatively less than 2.5, alternatively less than 2, alternatively less than 1.5, alternatively less than 1, alternatively less than 0.5, alternatively 0, mole % of (C) compounds of formula R—Oₐ—(C_{b}H_{2b}O)_{c}—R¹, where R is an ethylenically unsaturated group, R¹ is H or a hydrocarbyl group, subscript a is 0 or 1, subscript b is independently selected from 2 to 4 in each moiety indicated by subscript c, and subscript c is from 0 to 500, with the proviso that subscripts a and c are not simultaneously 0. The same description above relative to subscripts a, b, and c applies to component (C) as well. Examples of hydrocarbyl groups for R¹ are described above relative to R².

The ethylenically unsaturated group represented by R can be an alkenyl and/or alkynyl group having from 2 to 18, alternatively from 2 to 16, alternatively from 2 to 14, alternatively from 2 to 12, alternatively from 2 to 8, alternatively from 2 to 4, alternatively 2, carbon atoms. “Alkenyl” means an acyclic, branched or unbranched, monovalent hydrocarbon group having one or more carbon-carbon double bonds. Specific examples thereof include vinyl groups, allyl groups, hexenyl groups, and octenyl groups. “Alkynyl” means an acyclic, branched or unbranched, monovalent hydrocarbon group having one or more carbon-carbon triple bonds. Specific examples thereof include ethynyl, propynyl, and butynyl groups. Various examples of ethylenically unsaturated groups include CH₂═CH—, CH₂═CHCH₂—, CH₂═CH(CH₂)₄—, CH₂═CH(CH₂)₆—, CH₂═C(CH₃)CH₂—, H₂C═C(CH₃)—, H₂C═C(CH₃)—, H₂C═C(CH₃)CH₂—, H₂C═CHCH₂CH₂—, H₂C═CHCH₂CH₂CH₂—, HC≡C—, HC≡CCH₂—, HC≡CCH(CH₃)—, HC≡CC(CH₃)₂—, and HC≡CC(CH₃)₂CH₂—. Typically, ethylenic unsaturation is terminal in R. As understood in the art, ethylenic unsaturation may be referred to as aliphatic unsaturation.

Conventional carbinol-functional siloxanes are prepared via hydrosilylation reactions, whereby an organopolysiloxane having silicon-bonded hydrogen atoms is hydrosilylated with an alcohol or a polyether having one terminal unsaturated group (i.e., component (C)) in the presence of a hydrosilylation catalyst. To ensure no residual silicon-bonded hydrogen atoms remain, which can have undesirable reactivity in applications involving carbinol-functional siloxanes, a molar excess of component (C) is generally utilized. As a result, conventional carbinol-functional siloxanes are generally utilized as a reaction product including both the conventional carbinol-functional siloxanes but also residual amounts of component (C), which can often constitute around 30 mol % of the reaction product. Said differently, component (C) is inherently present along with conventional carbinol-functional siloxanes prepared via hydrosilylation. Because boiling point temperatures of conventional carbinol-functional siloxanes and component (C) are similar, particularly when the conventional carbinol-functional siloxanes are linear and have a DP less than 50, 40, 30, or 20, it's difficult and impractical to purify conventional carbinol-functional siloxanes by removing the residual amount of component (C) from the reaction product, e.g. via distillation or stripping. The residual amounts of component (C) cause undesirable byproducts and side reactions when conventional carbinol-functional siloxanes are utilized, e.g. in a further reaction. For example, component (C) is generally monovalent, and thus can react and serve as a chain terminating agent rather than a chain extender.

It has been surprisingly found, however, that by preparing component (A) via a method that is not hydrosilylation, the presence of residual amounts of component (C) can be minimized, alternatively eliminated. By using component (A) in its pure form, without residual amounts of component (C), component (A) can be used to prepare, for example, urethane prepolymers, or polyurethanes, or other reaction products having improved performance properties. In one embodiment, component (A) is prepared by a process comprising:
i) forming an aldehyde-functional siloxane by a process comprising: combining, under conditions to catalyze a hydroformylation reaction, starting materials comprising
   (I) a gas comprising hydrogen and carbon monoxide,
   (II) an alkenyl-functional siloxane, and
   (III) a rhodium/bisphosphite ligand complex catalyst;
optionally ii) recovering the aldehyde-functional siloxane,
iii) combining, under conditions to catalyze a hydrogenation reaction, starting materials comprising the aldehyde-functional siloxane, hydrogen, and a hydrogenation catalyst, thereby forming a hydrogenation reaction product comprising the carbinol-functional siloxane;
optionally iv) recovering the carbinol-functional siloxane;
optionally v) combining, under conditions to catalyze an alkoxylation reaction, starting materials comprising the carbinol-functional siloxane, an alkylene oxide, and an alkoxylation catalyst, therefrom forming a hydrogenation reaction product comprising the carbinol-functional siloxane in the form of a polyether-functional siloxane; and
optionally vi) recovering the carbinol-functional siloxane in the form of a polyether-functional siloxane.

The hydroformylation process described herein employs starting materials comprising: (I) a gas comprising hydrogen and carbon monoxide, (II) an alkenyl-functional siloxane, and (III) a rhodium/bisphosphite ligand catalyst. The starting materials may optionally further comprise: (IV) a solvent.

Starting material (I), the gas used in the hydroformylation process, comprises carbon monoxide (CO) and hydrogen gas (H₂). For example, the gas may be syngas. As used herein, “syngas” (from synthesis gas) refers to a gas mixture that contains varying amounts of CO and H₂. Production methods are well known and include, for example: (1) steam reforming and partial oxidation of natural gas or liquid hydrocarbons, and (2) the gasification of coal and/or biomass. CO and H₂ typically are the main components of syngas, but syngas may contain carbon dioxide and inert gases such as CH₄, N₂ and Ar. The molar ratio of H₂ to CO (H₂:CO molar ratio) varies greatly but may range from 1:100 to 100:1, alternatively 1:10 and 10:1. Syngas is commercially available and is often used as a fuel source or as an intermediate for the production of other chemicals. Alternatively, CO and H₂ from other sources (i.e., other than syngas) may be used as starting material (I) herein. Alternatively, the H₂:CO molar ratio in starting material (I) for use herein may be 3:1 to 1:3, alternatively 2:1 to 1:2, and alternatively 1:1.

Starting material (II), the alkenyl-functional siloxane, is selected based on the desired structure of component (A). The only difference between starting material (II) and component (A) is that the alkenyl-functional groups of starting material (II) are converted ultimately to carbinol-functional groups, but the structure of the siloxane itself is otherwise the same.

Starting material (III), the hydroformylation reaction catalyst for use in the method for making the aldehyde-functional siloxane comprises an activated complex of rhodium and a close ended bisphosphite ligand. The bisphosphite ligand may be symmetric or asymmetric. Alternatively, the bisphosphite ligand may be symmetric. The bisphosphite ligand may have formula (i):

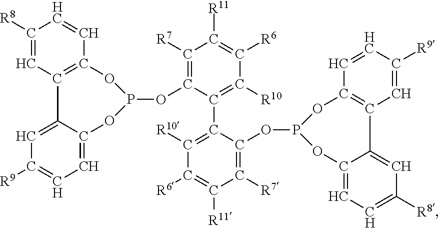

where R⁶ and R^{6′} are each independently selected from the group consisting of hydrogen, an alkyl group of at least one carbon atom, a cyano group, a halogen group, and an alkoxy group of at least one carbon atom; R⁷ and R^{7′} are each independently selected from the group consisting of an alkyl group of at least 3 carbon atoms and a group of formula —SiR¹⁷₃, where each R¹⁷ is an independently selected monovalent hydrocarbon group of 1 to 20 carbon atoms; R⁸, R^{8′}, R⁹, and R^{9′} are each independently selected from the group consisting of hydrogen, an alkyl group, a cyano group, a halogen group, and an alkoxy group; and R¹⁰, R^{10′}, R¹¹, and R^{11′} are each independently selected from the group consisting of hydrogen and an alkyl group. Alternatively, one of R⁷ and R^{7′} may be hydrogen.

In formula (i), R⁶ and R^{6′} may be alkyl groups of least one carbon atom, alternatively 1 to 20 carbon atoms. Suitable alkyl groups for R⁶ and R^{6′} may be linear, branched, cyclic, or combinations of two or more thereof. The alkyl groups are exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 20 carbon atoms), and the alkyl groups are further exemplified by cycloalkyl groups such as cyclopropyl, cyclobutyl, cyclopentyl, and cyclohexyl. Alternatively, the alkyl group for R⁶ and R^{6′} may be selected from the group consisting of ethyl, propyl and butyl; alternatively propyl and butyl. Alternatively, the alkyl group for R⁶ and R^{6′} may be butyl. Alternatively, R⁶ and R^{6′} may be alkoxy groups, wherein the alkoxy group may have formula —OR^{6″}, where R^{6″} is an alkyl group as described above for R⁶ and R^{6′}.

Alternatively, in formula (i), R⁶ and R^{6′} may be independently selected from alkyl groups of 1 to 6 carbon atoms and alkoxy groups of 1 to 6 carbon atoms. Alternatively, R⁶ and R^{6′} may be alkyl groups of 2 to 4 carbon atoms. Alternatively, R⁶ and R^{6′} may be alkoxy groups of 1 to 4 carbon atoms. Alternatively, R⁶ and R^{6′} may be butyl groups, alternatively tert-butyl groups. Alternatively, R⁶ and R^{6′} may be methoxy groups.

In formula (i), R⁷ and R^{7′} may be alkyl groups of least three carbon atoms, alternatively 3 to 20 carbon atoms. Suitable alkyl groups for R⁷ and R^{7′} may be linear, branched, cyclic, or combinations of two or more thereof. The alkyl groups are exemplified by propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 20 carbon atoms), and the alkyl groups are further exemplified by cycloalkyl groups such as cyclopropyl, cyclobutyl, cyclopentyl, and cyclohexyl. Alternatively, the alkyl group for R⁷ and R^{7′} may be selected from the group consisting of propyl and butyl. Alternatively, the alkyl group for R⁷ and R^{7′} may be butyl.

Alternatively, in formula (i), R⁷ and R^{7′} may be a silyl group of formula —SiR¹⁷₃, where each R¹⁷ is an independently selected monovalent hydrocarbon group of 1 to 20 carbon atoms. The monovalent hydrocarbon group may be an alkyl group of 1 to 20 carbon atoms, as described above for R⁶ and R^{6′}.

Alternatively, in formula (i), R⁷ and R^{7′} may each be independently selected alkyl groups, alternatively alkyl groups of 3 to 6 carbon atoms. Alternatively, R⁷ and R^{7′} may be alkyl groups of 3 to 4 carbon atoms. Alternatively, R⁷ and R^{7′} may be butyl groups, alternatively tert-butyl groups.

In formula (i), R⁸, R^{8′}, R⁹, R^{9′} may be alkyl groups of at least one carbon atom, as described above for R⁶ and R^{6′}. Alternatively, R⁸ and R^{8′} may be independently selected from the group consisting of hydrogen and alkyl groups of 1 to 6 carbon atoms. Alternatively, R⁸ and R^{8′} may be hydrogen. Alternatively, in formula (i), R⁹, and R^{9′} may be independently selected from the group consisting of hydrogen and alkyl groups of 1 to 6 carbon atoms. Alternatively, R⁹ and R^{9′} may be hydrogen.

In formula (i), R¹⁰ and R^{10′} may be hydrogen atoms or alkyl groups of least one carbon atom, alternatively 1 to 20 carbon atoms. The alkyl groups for R¹⁰ and R^{10′} may be as described above for R⁶ and R^{6′}. Alternatively, R¹⁰ and R^{10′} may be methyl. Alternatively, R¹⁰ and R^{10′} may be hydrogen.

In formula (i), R¹¹ and R^{11′} may be hydrogen atoms or alkyl groups of least one carbon atom, alternatively 1 to 20 carbon atoms. The alkyl groups for R¹¹ and R^{11′} may be as described above for R⁶ and R^{6′}. Alternatively, R¹¹ and R^{11′} may be hydrogen.

Alternatively, the ligand of formula (i) may be selected from the group consisting of (C1-1) 6,6′-[[3,3′,5,5′-tetrakis(1,1-dimethylethyl)-1,1′-biphenyl]-2,2′-diyl]bis(oxy)]bis-dibenzo[d,f][1,3,2]dioxaphosphepin; (C₁₋₂) 6,6′-[(3,3′-di-tert-butyl-5,5′-dimethoxy-1,1′-biphenyl-2,2′-diyl)bis(oxy)]bis(dibenzo[d,f][1,3,2]dioxaphosphepin); and a combination of both (C1-1) and (C1-2).

Alternatively, the ligand may comprise 6,6′-[[3,3′,5,5′-tetrakis(1,1-dimethylethyl)-1,1′-biphenyl]-2,2′-diyl]bis(oxy)]bis-dibenzo[d,f][1,3,2]dioxaphosphepin, as disclosed at col. 11 of U.S. Pat. No. 10,023,516 (see also U.S. Pat. No. 7,446,231, which discloses this compound as Ligand D at col. 22 and U.S. Pat. No. 5,727,893 at col. 20, lines 40-60 as ligand F).

Alternatively, the ligand may comprise biphephos, which is commercially available from Sigma Aldrich and may be prepared as described in U.S. Pat. No. 9,127,030. (See also U.S. Pat. No. 7,446,231 ligand B at col. 21 and U.S. Pat. No. 5,727,893 at col. 20, lines 5-18 as ligand D).

Starting material (III), the rhodium/bisphosphite ligand complex catalyst, may be prepared by methods known in the art, such as those disclosed in U.S. Pat. No. 4,769,498 to Billig, et al. at col. 20, line 50-col. 21, line 40 and U.S. Pat. No. 10,023,516 to Brammer et al. col. 11, line 35-col. 12, line 12 by varying appropriate starting materials. For example, the rhodium/bisphosphite ligand complex may be prepared by a process comprising combining a rhodium precursor and the bisphosphite ligand (i) described above under conditions to form the complex, which complex may then be introduced into a hydroformylation reaction medium comprising one or both of starting materials (I) and/or (II), described above. Alternatively, the rhodium/bisphosphite ligand complex may be formed in situ by introducing the rhodium catalyst precursor into the reaction medium, and introducing (i) the bisphosphite ligand into the reaction medium (e.g., before, during, and/or after introduction of the rhodium catalyst precursor), for the in situ formation of the rhodium/bisphosphite ligand complex. The rhodium/bisphosphite ligand complex can be activated by heating and/or exposure to starting material (I) to form the (III) rhodium/bisphosphite ligand complex catalyst. Rhodium catalyst precursors are exemplified by rhodium dicarbonyl acetylacetonate, Rh₂O₃, Rh₄(CO)₁₂, Rh₆(CO)₁₆, and Rh(NO₃)₃.

For example, a rhodium precursor, such as rhodium dicarbonyl acetylacetonate, optionally starting material (IV), a solvent, and (i) the bisphosphite ligand may be combined, e.g., by any convenient means such as mixing. The resulting rhodium/bisphosphite ligand complex may be introduced into the reactor, optionally with excess bisphosphite ligand. Alternatively, the rhodium precursor, (IV) the solvent, and the bisphosphite ligand may be combined in the reactor with starting material (I) and/or (II), the alkenyl-functional siloxane; and the rhodium/bisphosphite ligand complex may form in situ. The relative amounts of bisphosphite ligand and rhodium precursor are sufficient to provide a molar ratio of bisphosphite ligand/Rh of 10/1 to 1/1, alternatively 5/1 to 1/1, alternatively 3/1 to 1/1, alternatively 2.5/1 to 1.5/1. In addition to the rhodium/bisphosphite ligand complex, excess (e.g., not complexed) bisphosphite ligand may be present in the reaction mixture. The excess bisphosphite ligand may be the same as, or different from, the bisphosphite ligand in the complex.

The amount of (III) the rhodium/bisphosphite ligand complex catalyst (catalyst) is sufficient to catalyze hydroformylation of (II) the alkenyl-functional siloxane. The exact amount of catalyst will depend on various factors including the type of alkenyl-functional siloxane selected for starting material (II), its exact alkenyl content, and the reaction conditions such as temperature and pressure of starting material (I). However, the amount of (III) the hydroformylation reaction catalyst may be sufficient to provide a rhodium metal concentration of at least 0.1 ppm, alternatively 0.15 ppm, alternatively 0.2 ppm, alternatively 0.25 ppm, and alternatively 0.5 ppm, based on the weight of (II) the alkenyl-functional siloxane. At the same time, the amount of (III) the hydroformylation reaction catalyst may be sufficient to provide a rhodium metal concentration of up to 300 ppm, alternatively up to 100 ppm, alternatively up to 20 ppm, and alternatively up to 5 ppm, on the same basis. Alternatively, the amount of (III) the hydroformylation reaction catalyst may be sufficient to provide 0.1 ppm to 300 ppm, alternatively 0.2 ppm to 100 ppm, alternatively, 0.25 ppm to 20 ppm, and alternatively 0.5 ppm to 5 ppm, based on the weight of (II) the alkenyl-functional siloxane.

The hydroformylation process reaction may run without additional solvents. Alternatively, the hydroformylation process reaction may be carried out with a solvent.

In the process described herein, step 1) is performed at relatively low temperature. For example, step 1) may be performed at a temperature of at least 30° C., alternatively at least 50° C., and alternatively at least 70° C. At the same time, the temperature in step 1) may be up to 150° C.; alternatively up to 100° C.; alternatively up to 90° C., and alternatively up to 80° C. Without wishing to be bound by theory, it is thought that lower temperatures, e.g., 30° C. to 90° C., alternatively 40° C. to 90° C., alternatively 50° C. to 90° C., alternatively 60° C. to 90° C., alternatively 70° C. to 90° C., alternatively 80° C. to 90° C., alternatively 30° C. to 60° C., alternatively 50° C. to 60° C. may be desired for achieving high selectivity and ligand stability.

In the process described herein, step 1) may be performed at a pressure of at least 101 kPa (ambient), alternatively at least 206 kPa (30 psi), and alternatively at least 344 kPa (50 psi). At the same time, pressure in step 1) may be up to 6,895 kPa (1,000 psi), alternatively up to 1,379 kPa (200 psi), alternatively up to 1000 kPa (145 psi), and alternatively up to 689 kPa (100 psi). Alternatively, step 1) may be performed at 101 kPa to 6,895 kPa; alternatively 344 kPa to 1,379 kPa; alternatively 101 kPa to 1,000 kPa; and alternatively 344 kPa to 689 kPa. Without wishing to be bound by theory, it is thought that using relatively low pressures, e.g., <6,895 kPa in the process herein may be beneficial; the ligands described herein allow for low pressure hydroformylation processes, which have the benefits of lower cost and better safety than high pressure hydroformylation processes.

The hydroformylation process may be carried out in a batch, semi-batch, or continuous mode, using one or more suitable reactors, such as a fixed bed reactor, a fluid bed reactor, a continuous stirred tank reactor (CSTR), or a slurry reactor. The selection of (II) the alkenyl-functional siloxane, and (III) the hydroformylation reaction catalyst, and whether (IV) the solvent is used may impact the size and type of reactor used. One reactor, or two or more different reactors, may be used. The hydroformylation process may be conducted in one or more steps, which may be affected by balancing capital costs and achieving high catalyst selectivity, activity, lifetime, and ease of operability, as well as the reactivity of the particular starting materials and reaction conditions selected, and the desired product.

Alternatively, the hydroformylation process may be performed in a continuous manner. For example, the process used may be as described in U.S. Pat. No. 10,023,516 except that the olefin feed stream and catalyst described therein are replaced with (II) the alkenyl-functional siloxane and (III) the rhodium/bisphosphite ligand complex catalyst, each described herein.

Step 1) of the hydroformylation process forms a reaction fluid comprising the aldehyde-functional siloxane. The reaction fluid may further comprise additional materials, such as those which have either been deliberately employed, or formed in situ, during step 1) of the process. Examples of such materials that can also be present include unreacted (II) alkenyl-functional siloxane, unreacted (I) carbon monoxide and hydrogen gases, and/or in situ formed side products, such as ligand degradation products and adducts thereof, and high boiling liquid aldehyde condensation byproducts, as well as (IV) a solvent, if employed. The term “ligand degradation product” includes but is not limited to any and all compounds resulting from one or more chemical transformations of at least one of the ligand molecules used in the process.

The hydroformylation process may further comprise one or more additional steps such as: 2) recovering (III) the rhodium/bisphosphite ligand complex catalyst from the reaction fluid comprising the aldehyde-functional siloxane. Recovering (III) the rhodium/bisphosphite ligand complex catalyst may be performed by methods known in the art, including but not limited to adsorption and/or membrane separation (e.g., nanofiltration). Suitable recovery methods are as described, for example, in U.S. Pat. No. 5,681,473 to Miller, et al.; U.S. Pat. No. 8,748,643 to Priske, et al.; and 10,155,200 to Geilen, et al.

However, one benefit of the process described herein is that (III) the hydroformylation reaction catalyst need not be removed and recycled. Due to the low level of Rh needed, it may be more cost effective not to recover and recycle (III) the hydroformylation reaction catalyst; and the aldehyde-functional siloxane produced by the process may be stable even when the hydroformylation reaction catalyst is not removed. Furthermore, without wishing to be bound by theory, it is thought that (III) the hydroformylation reaction catalyst may also catalyze the hydrogenation reaction of the aldehyde-functional siloxane to form the carbinol-functional siloxane, as described herein below. Therefore, alternatively, the hydroformylation process described above may be performed without step 2).

Alternatively, the hydroformylation process may further comprise 3) purification of the reaction product. For example, the aldehyde-functional siloxane may be isolated from the additional materials, described above, by any convenient means such as stripping and/or distillation, optionally with reduced pressure. Alternatively, step 3) may be omitted, for example, to leave (III) the hydroformylation reaction catalyst in the hydroformylation reaction product comprising the aldehyde-functional siloxane.

The aldehyde-functional siloxane is useful as a starting material in the process above for preparing a carbinol-functional siloxane. Starting material (V) is the aldehyde-functional siloxane, which has, per molecule, at least one aldehyde-functional group covalently bonded to silicon. Alternatively, the aldehyde-functional siloxane may have, per molecule, more than one aldehyde-functional group covalently bonded to silicon. The aldehyde-functional group covalently bonded to silicon may have formula:

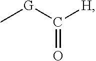

where G is a divalent hydrocarbon group free of aliphatic unsaturation that has 2 to 8 carbon atoms. G may be linear or branched. Examples of divalent hydrocarbyl groups for G include alkane-diyl groups of empirical formula —CᵣH₂ᵣ—, where subscript r is 2 to 8. The alkane-diyl group may be a linear alkane-diyl, e.g., —CH₂—CH₂—, —CH₂—CH₂—CH₂—, —CH₂—CH₂—CH₂—CH₂—, or —CH₂—CH₂—CH₂—CH₂—CH₂—CH₂—, or a branched alkane-diyl, e.g.,

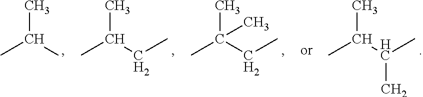

Alternatively, each G may be an alkane-diyl group of 2 to 6 carbon atoms; alternatively of 2, 3, or 6 carbon atoms.

The process for preparing the carbinol-functional siloxane may comprise:
I) combining, under conditions to catalyze hydrogenation reaction, starting materials comprising
   (V) the aldehyde-functional siloxane described above,
   (VI) hydrogen, and
   (VII) a hydrogenation catalyst, thereby forming a hydrogenation reaction product comprising the carbinol-functional siloxane.

The process may optionally further comprise, before step I), J) combining, under conditions to catalyze hydroformylation reaction, starting materials comprising (I) the gas comprising hydrogen and carbon monoxide, (II) the alkenyl-functional siloxane, and (III) the rhodium/bisphosphite ligand complex catalyst, thereby forming a hydroformylation reaction product comprising the aldehyde-functional siloxane as described above. The process may optionally further comprise, before step I) and after step i), step ii) recovering (III) the rhodium/bisphosphite ligand complex catalyst from the reaction product comprising the aldehyde-functional siloxane. The process may optionally further comprise, before step I) and after step i), iii) purifying the reaction product; thereby isolating the aldehyde-functional siloxane from the additional materials, as described above.

Hydrogen is known in the art and commercially available from various sources, e.g., Air Products of Allentown, Pennsylvania, USA. Hydrogen may be used in a superstoichiometric amount with respect to the aldehyde-functionality of starting material (V), the aldehyde-functional siloxane described above, to permit complete hydrogenation.

The hydrogenation catalyst used in the process for preparing the carbinol-functional siloxane may be a heterogeneous hydrogenation catalyst, a homogenous hydrogenation catalyst, or a combination thereof. Alternatively, the hydrogenation catalyst may be a heterogeneous hydrogenation catalyst. Suitable heterogeneous hydrogenation catalysts comprise a metal selected from the group consisting cobalt (Co), copper (Cu), nickel (Ni), palladium (Pd), platinum (Pt), ruthenium (Ru), and a combination of two or more thereof. Alternatively, the hydrogenation catalyst may comprise Co, Cu, Ni, Pd, or a combination of two or more thereof. Alternatively, the hydrogenation catalyst may comprise Co, Cu, Ni, or a combination of two or more thereof. The hydrogenation catalyst may include a support, such as alumina (Al₂O₃), silica (SiO₂), silicon carbide (SiC), or carbon (Ill). Alternatively, the hydrogenation catalyst may be selected from the group consisting of Raney nickel, Raney copper, Ru/C, Ru/Al₂O₃, Pd/C, Pd/Al₂O₃, Cu/C, Cu/Al₂O₃, Cu/SiO₂, Cu/SiC, Cu/C, and a combination of two or more thereof.

Alternatively, heterogeneous hydrogenation catalysts for hydrogenation of aldehydes may include a support material on which copper, chromium, nickel, or two or more thereof are applied as active components. Exemplary catalysts include copper at 0.3 to 15%; nickel at 0.3% to 15%, and chromium at 0.05% to 3.5%. The support material may be, for example, porous silicon dioxide or aluminium oxide. Barium may optionally be added to the support material. Chromium free hydrogenation catalysts may alternatively be used. For example a Ni/Al₂O₃ or Co/Al₂O₃ may be used, or a copper oxide/zinc oxide containing catalyst, which further comprises potassium, nickel, and/or cobalt; and additionally an alkali metal. Suitable hydrogenation catalysts are disclosed for example, in U.S. Pat. No. 7,524,997 or U.S. Pat. No. 9,567,276 and the references cited therein.

Examples of suitable heterogeneous hydrogenation catalysts for use herein include Raney Nickel such as Raney Nickel 2400, Ni-3288, Raney Copper, Hysat 401 salt (Cu), Ruthenium on carbon (Ru/C), platinum on carbon (Pt/C), copper on silicon carbide (Cu/SiC).

Alternatively, a homogeneous hydrogenation reaction catalyst may be used herein. The homogeneous hydrogenation catalyst may be a metal complex, where the metal may be selected from the group consisting of Co, Fe, Ir, Rh, and Ru. Examples of suitable homogeneous hydrogenation catalysts are exemplified by [RhCl(PPh₃)₃](Wilkinson's catalyst); [Rh(NBD)(PR′₃)₂]+ClO₄— (where R′ is an alkyl group, e.g. Et); [RuCl₂(diphosphine)(1,2-diamine)](Noyori catalysts); RuCl₂(TRIPHOS) (where TRIPHOS=PhP[(CH₂CH₂PPh₂)₂]; Ru(II)(dppp)(glycine) complexes (where dppp=1,3-bis(diphenylphosphino)propane); RuCl₂(PPh₃)₃; RuCl₂(CO)₂(PPh₃)₂; IrH₃(PPh₃)₃; [Ir(H₂)(CH₃COO)(PPh₃)₃]; cis-[Ru—Cl2(ampy)(PP)][where ampy=2-(aminomethyl)pyridine; and PP=1,4-bis-(diphenylphosphino)butane, 1,1′-ferrocenediyl-bis(diphenylphosphine)]; Pincer RuCl(CNNR)(PP) complexes [where PP=1,3-bis(diphenylphosphino)propane, 1,4-bis(diphenylphosphino)butane, 1,1′-ferrocenediyl-bis(diphenylphosphine); and HCNNR=4-substituted-aminomethyl-benzo[h]quinoline; R=Me, Ph]; [RuCl₂(dppb)(ampy)](where dppb=1,4-Bis(diphenylphosphino)butane, ampy=2-aminomethyl pyridine); [Fe(PNPMeiPr)(CO)(H)(Br)]; [Fe(PNPMe-iPr)(H)2(CO)]; and a combination thereof.

The amount of hydrogenation catalyst used in the process depends on various factors including whether the process will be run in a batch or continuous mode, the selection of aldehyde-functional siloxane, whether a heterogeneous or homogeneous hydrogenation catalyst is selected, and reaction conditions such as temperature and pressure. However, when the process is run in a batch mode the amount of catalyst may be 1 weight % to 20 weight %, alternatively 5 weight % to 10 weight %, based on weight of the aldehyde-functional siloxane. Alternatively, the amount of catalyst may be at least 1, alternatively at least 4, alternatively at least 6.5, and alternatively at least 8, weight %; while at the same time the amount of catalyst may be up to 20, alternatively up to 14, alternatively up to 13, alternatively up to 10, and alternatively up to 9, weight %, on the same basis. Alternatively, when the process will be run in a continuous mode, e.g., by packing a fixed bed reactor with a heterogeneous hydrogenation catalyst, the amount of the hydrogenation catalyst may be sufficient to provide a reactor volume (filled with hydrogenation catalyst) to achieve a space time of 10 hr⁻¹, or catalyst surface area sufficient to achieve 10 kg/hr substrate per m² of catalyst.

A solvent that may optionally be used in the process for hydrogenation reaction may be selected from those solvents that are neutral to the reaction. The following are specific examples of such solvents: monohydric alcohols such as ethanol and isopropyl alcohol; dioxane, ethers such as THF; aliphatic hydrocarbons, such as hexane, heptane, and paraffinic solvents; and aromatic hydrocarbons such as benzene, toluene, and xylene; chlorinated hydrocarbons, and water. These solvents can be used individually or in combinations of two or more.

The hydrogenation reaction can be performed using pressurized hydrogen. Hydrogen (gauge) pressure may be 10 psig (68.9 kPa) to 3000 psig (20684 kPa), alternatively 10 psig to 2000 psig (13790 kPa), alternatively 10 psig to 800 psig (5516 kPa), alternatively 50 psig (345 kPa) to 200 psig (1379 kPa). The reaction may be carried out at a temperature of 0 to 200° C. Alternatively, a temperature of 50 to 150° C. may be suitable for shortening the reaction time. Alternatively, the hydrogen (gauge) pressure used may be at least 25, alternatively at least 50, alternatively at least 100, alternatively at least 150, and alternatively at least 164, psig; while at the same time the hydrogen gauge pressure may be up to 800, alternatively up to 400, alternatively up to 300, alternatively up to 200, and alternatively up to 194, psig. The temperature for hydrogenation reaction may be at least 50, alternatively at least 65, alternatively at least 80, ° C., while at the same time the temperature may be up to 200, alternatively up to 150, alternatively up to 120, ° C.

The hydrogenation reaction can be carried out as a batch process or as a continuous process. In a batch process, the reaction time depends on various factors including the amount of the catalyst and reaction temperatures, however, the hydrogenation reaction may be performed for 1 minute to 24 hours. Alternatively, the hydrogenation reaction may be performed for at least 1 minute, alternatively at least 2 minutes, alternatively at least 1 hour, alternatively at least 2.5 hours, alternatively at least 3 hours, alternatively at least 3.3 hours, alternatively at least 3.7 hours, alternatively at least 4 hours, alternatively at least 4.4 hours, and alternatively at least 5.5 hours; while at the same time, the hydrogenation reaction may be performed for up to 24 hours, alternatively up to 22.5 hours, alternatively up to 22 hours, alternatively up to 12 hours, alternatively up to 7 hours, and alternatively up to 6 hours.

Alternatively, in a batch process, the terminal point of a hydrogenation reaction can be considered to be the time during which the decrease in pressure of hydrogen is no longer observed after the reaction is continued for an additional 1 to 2 hours. If hydrogen pressure decreases in the course of the reaction, it may be desirable to repeat the introduction of hydrogen and to maintain it under increased pressure to shorten the reaction time. Alternatively, the reactor can be re-pressurized with hydrogen 1 or more times to achieve sufficient supply of hydrogen for reaction of the aldehyde while maintaining reasonable reactor pressures.

After completion of the hydrogenation reaction, the hydrogenation catalyst may be separated in a pressurized inert (e.g., nitrogenous) atmosphere by any convenient means, such as filtration or adsorption, e.g., with diatomaceous earth or activated carbon, settling, centrifugation, by maintaining the catalyst in a structured packing or other fixed structure, or a combination thereof.

The carbinol-functional siloxane prepared as described above has, per molecule, at least one carbinol-functional group covalently bonded to silicon. Alternatively, the carbinol-functional siloxane may have, per molecule, more than one carbinol-functional group covalently bonded to silicon. The carbinol-functional group covalently bonded to silicon, Roar, may have formula:

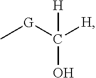

where G is a divalent hydrocarbon group free of aliphatic unsaturation that has 2 to 8 carbon atoms, as described and exemplified above. Examples of the carbinol functional siloxane prepared by this process are as described and exemplified above.

Starting material (IV) is the solvent that may optionally be used in the method for making the polyether-functional siloxane. The solvent may be added to facilitate mixing and/or delivery of one or more of the starting materials described above. For example, (II) the halogenated triarylborane Lewis acid may be delivered in a solvent. Alternatively, (Ill) the carbinol-functional siloxane may be delivered in a solvent, for example, when the carbinol-functional siloxane comprises a carbinol-functional polyorganosiloxane resin.

Suitable solvents include those that will not react with the starting materials used in step (1). Solvents for use in step (1) include liquid hydrocarbons. For example, the hydrocarbon solvent may be an aromatic hydrocarbon such as benzene, ethylbenzene, toluene, xylene, or an aliphatic hydrocarbon such as heptane, or a combination of both an aromatic hydrocarbon and an aliphatic hydrocarbon. Alternatively, the solvent may comprise a liquid non-functional siloxane such as low viscosity linear and cyclic polydiorganosiloxanes. The amount of solvent is not critical and depends on various factors including whether (Ill) the carbinol-functional siloxane is a solid under ambient conditions (e.g., a carbinol-functional polyorgansiloxane resin), and the type of reactor selected for alkoxylation. However the amount of solvent used during the alkoxylation reaction in step (1) may be 1% to 90% based on combined weights of (I) the epoxide, (II) the halogenated triarylborane Lewis acid, and (Ill) the carbinol-fucntional siloxane.

When the carbinol-functional groups of component (A) are polyether groups, the method to prepare component (A) may further comprise combining, under conditions to catalyze an alkoxylation reaction, starting materials comprising the carbinol-functional siloxane, an alkylene oxide, and an alkoxylation catalyst, therefrom forming a hydrogenation reaction product comprising the carbinol-functional siloxane in the form of a polyether-functional siloxane.

The alkylene oxide is selected based on the desired structure of the polyether groups of component (A), when present. The alkylene oxide may be, for example, ethylene oxide, propylene oxide, butylene oxide, hexylene oxide, decylene oxide, or a combination of two or more thereof.

Additional description for preparing component (A) is disclosed in 84744-US-PSP, which is incorporated by reference herein in its entirety.

In certain embodiments, the composition further comprises (D) a polyol. In specific embodiments, the (D) polyol comprises, alternatively consists of, a polyether polyol. Polyether polyols suitable for the composition include, but are not limited to, products obtained by the polymerization of a cyclic oxide, for example, ethylene oxide (“EO”), propylene oxide (“PO”), butylene oxide (“BO”), tetrahydrofuran, or epichlorohydrin, in the presence of polyfunctional initiators. Suitable initiators contain more than one, i.e., a plurality of, active hydrogen atoms. Catalysis for this polymerization can be either anionic or cationic, with suitable catalysts including KOH, CsOH, boron trifluoride, or a double metal cyanide complex (DMC) catalyst such as zinc hexacyanocobaltate or a quaternary phosphazenium compound. The initiator may be selected from, for example, neopentylglycol; 1,2-propylene glycol; water; trimethylolpropane; pentaerythritol; sorbitol; sucrose; glycerol; aminoalcohols, such as ethanolamine, diethanolamine, and triethanolamine; alkanediols, such as 1,6-hexanediol, 1,4-butanediol, 1,3-butane diol, 2,3-butanediol, 1,3-propanediol, 1,2-propanediol, 1,5-pentanediol, 2-methylpropane-1,3-diol, 1,4-cyclohexane diol, 1,3-cyclohexanedimethanol, 1,4-cyclohexanedimethanol, and/or 2,5-hexanediol; ethylene glycol; diethylene glycol; triethylene glycol; bis-3-aminopropyl methylamine; ethylene diamine; diethylene triamine; 9(1)-hydroxymethyloctadecanol; 1,4-bishydroxymethylcyclohexane; hydrogenated bisphenol; 9,9(10,10)-bishydroxymethyloctadecanol; 1,2,6-hexanetriol; and combinations thereof. Other initiators include other linear and cyclic compounds containing an amine group. Exemplary polyamine initiators include ethylene diamine, neopentyldiamine, 1,6-diaminohexane; bisaminomethyltricyclodecane; bisaminocyclohexane; diethylene triamine; bis-3-aminopropyl methylamine; triethylene tetramine; various isomers of toluene diamine; diphenylmethane diamine; N-methyl-1,2-ethanediamine, N-methyl-1,3-propanediamine; N,N-dimethyl-1,3-diaminopropane; N,N-dimethylethanolamine; 3,3′-diamino-N-methyldipropylamine; N,N-dimethyldipropylenetriamine; aminopropyl-imidazole; and combinations thereof. As understood in the art, the initiator compound, or combination thereof, is generally selected based on desired functionality of the resulting polyether polyol.

Other suitable polyether polyols include polyether diols and triols, such as polyoxypropylene diols and triols and poly(oxyethylene-oxypropylene)diols and triols obtained by the simultaneous or sequential addition of ethylene and propylene oxides to di- or tri-functional initiators. Polyether polyols having higher functionalities than triols can also be utilize in lieu of or in addition to polyether diols and/or triols. Copolymers having an oxyethylene content of from 5 to 90% by weight, based on the weight of the copolymer, can be utilized. When the (D) polyol is a copolymer, the copolymer can be a block copolymer, a random/block copolymer or a random copolymer. the (D) polyol can also be a terpolymer. Yet other suitable polyether polyols include polytetramethylene glycols obtained by the polymerization of tetrahydrofuran.

In other embodiments, the (D) polyol comprises, alternatively consists of, a polyester polyol. Polyester polyols suitable for the composition include, but are not limited to, hydroxyl-functional reaction products of polyhydric alcohols (including mixtures thereof), such as ethylene glycol, propylene glycol, diethylene glycol, 1,4-butanediol, neopentylglycol, 1,6-hexanediol, cyclohexane dimethanol, glycerol, trimethylolpropane, pentaerythritol, sucrose, polyether polyols; and polycarboxylic acids, particularly dicarboxylic acids or their ester-forming derivatives, for example succinic, glutaric and adipic acids or their dimethyl esters, sebacic acid, phthalic anhydride, tetrachlorophthalic anhydride, dimethyl terephthalate or mixtures thereof. Polyester polyols obtained by the polymerization of lactones, e.g. caprolactone, in conjunction with a polyol, or of hydroxy carboxylic acids, e.g. hydroxy caproic acid, may also be used. In certain embodiments, the (D) polyol comprises a mixture of polyester and polyether polyols.

Suitable polyesteramide polyols may be obtained by the inclusion of aminoalcohols such as ethanolamine in polyesterification mixtures. Suitable polythioether polyols include products obtained by condensing thiodiglycol either alone or with other glycols, alkylene oxides, dicarboxylic acids, formaldehyde, aminoalcohols or aminocarboxylic acids. Suitable polycarbonate polyols include products obtained by reacting diols such as 1,3-propanediol, 1,4-butanediol, 1,6-hexanediol, diethylene glycol or tetraethylene glycol with diaryl carbonates, e.g. diphenyl carbonate, or with phosgene. Suitable polyacetal polyols include those prepared by reacting glycols such as diethylene glycol, triethylene glycol or hexanediol with formaldehyde. Other suitable polyacetal polyols may also be prepared by polymerizing cyclic acetals. Suitable polyolefin polyols include hydroxy-terminated butadiene homo- and copolymers and suitable polysiloxane polyols include polydimethylsiloxane diols and triols.

In certain embodiments, the (D) polyol is a polymer polyol. In specific embodiments, the polymer polyol is a graft polyol. Graft polyols may also be referred to as graft dispersion polyols or graft polymer polyols. Graft polyols often include products, i.e., polymeric particles, obtained by the in-situ polymerization of one or more vinyl monomers, e.g. styrene monomers and/or acrylonitrile monomers, and a macromer in a polyol, e.g. a polyether polyol.

In other embodiments, the polymer polyol is chosen from polyharnstoff (PHD) polyols, polyisocyanate polyaddition (PIPA) polyols, and combinations thereof. PHD polyols are typically formed by in-situ reaction of a diisocyanate with a diamine in a polyol to give a stable dispersion of polyurea particles. PIPA polyols are similar to PHD polyols, except that the dispersion is typically formed by in-situ reaction of a diisocyanate with an alkanolamine instead of a diamine, to give a polyurethane dispersion in a polyol. In yet other embodiments, the polymer polyol comprises a co-polymer polyol based on styrene-acrylonitrile (SAN).

It is to be appreciated that the (D) polyol utilized in the composition may include any combination of two or more polyols that are different from one another based on functionality, molecular weight, viscosity, or structure.

In various embodiments, the (D) polyol has a hydroxyl (OH) number of from greater than 10 to 120, alternatively from 20 to 90, alternatively from 30 to 80, alternatively from 40 to 70, alternatively from 50 to 60, mg KOH/g. Hydroxyl number can be measured via various techniques, such as in accordance with ASTM D4274. In these or other embodiments, the (D) polyol has a number average molecular weight of from 1,000 to 4,000, alternatively from 1,250 to 3,000, alternatively from 1,500 to 2,500, alternatively from 1,750 to 2,250, alternatively from 1,900 to 2,100, Daltons. As readily understood in the art, number average molecular weight can be measured via gel permeation chromatography (GPC).

In these or other embodiments, the (D) polyol has a functionality of from 2 to 10, alternatively from 2 to 9, alternatively from 2 to 8, alternatively from 2 to 7, alternatively from 2 to 6, alternatively from 2 to 5, alternatively from 2 to 4, alternatively from 2 to 3, alternatively 2.

It is to be appreciated that when the (D) polyol comprises a blend of two or more different polyols, the properties above may be based on the overall (D) polyol, i.e., averaging the properties of the individual polyols in the (D) polyol, or may relate to a specific polyol in the blend of polyols. Typically, these properties relate to the overall (D) polyol. In specific embodiments, the (D) polyol comprises, alternatively consists essentially of, alternatively consists of, one or more polyether polyols. Said differently, in these embodiments, the (D) polyol is typically free from any polyols that are not polyether polyols. In these or other embodiments, the (D) polyol comprises, alternatively is, a homopolymer diol and/or triol.

In certain embodiments, the composition comprises component (D) in an amount of from greater than 0 to 80, alternatively from 10 to 70, alternatively from 20 to 60, alternatively from 30 to 50, weight percent based on the total weight of the composition.

In certain embodiments, the composition further comprises a (E) catalyst. That (E) catalyst, if utilized, typically catalyzes the formation of urethane bonds in reacting components (A) and (B) and optionally component (D), as described below.

In one embodiment, the (E) catalyst comprises a tin catalyst. Suitable tin catalysts include tin(II) salts of organic carboxylic acids, e.g. tin(II) acetate, tin(II) octoate, tin(II) ethylhexanoate and tin(II) laurate. In one embodiment, the (E) catalyst comprises dibutyltin dilaurate, which is a dialkyltin(IV) salt of an organic carboxylic acid. Specific examples of suitable organometallic catalyst, e.g. dibutyltin dilaurates, are commercially available from Evonik under the trademark DABCO™. The organometallic catalyst can also comprise other dialkyltin(IV) salts of organic carboxylic acids, such as dibutyltin diacetate, dibutyltin maleate and dioctyltin diacetate.

Examples of other suitable catalysts include iron(II) chloride; zinc chloride; lead octoate; tris(dialkylaminoalkyl)-s-hexahydrotriazines, including tris(N,N-dimethylaminopropyl)-s-hexahydrotriazine; tetraalkylammonium hydroxides, including tetramethylammonium hydroxide; alkali metal hydroxides, including sodium hydroxide and potassium hydroxide; alkali metal alkoxides, including sodium methoxide and potassium isopropoxide; and alkali metal salts of long-chain fatty acids having from 10 to 20 carbon atoms and/or lateral OH groups.

Further examples of other suitable catalysts, specifically trimerization catalysts, include N,N,N-dimethylaminopropylhexahydrotriazine, potassium, potassium acetate, N,N,N-trimethyl isopropyl amine/formate, and combinations thereof.

Yet further examples of other suitable catalysts, specifically tertiary amine catalysts, include dimethylaminoethanol, dimethylaminoethoxyethanol, triethylamine, N,N,N′,N′-tetramethylethylenediamine, triethylenediamine (also known as 1,4-diazabicyclo[2.2.2]octane), N,N-dimethylaminopropylamine, N,N,N′,N′,N″-pentamethyldipropylenetriamine, tris(dimethylaminopropyl)amine, N,N-dimethylpiperazine, tetramethylimino-bis(propylamine), dimethylbenzylamine, trimethylamine, triethanolamine, N,N-diethyl ethanolamine, N-methylpyrrolidone, N-methylmorpholine, N-ethylmorpholine, bis(2-dimethylamino-ethyl)ether, N,N-dimethylcyclohexylamine (“DMCHA”), N,N,N′,N′,N″-pentamethyldiethylenetriamine, 1,2-dimethylimidazole, 3-(dimethylamino) propylimidazole, 2,4,6-tris(dimethylaminomethyl) phenol, and combinations thereof. The (E) catalyst can comprise delayed action tertiary amine based on 1,8-diazabicyclo[5.4.0]undec-7-ene (“DBU”). Alternatively or in addition, the (E) catalyst can comprise N,N,N′-trimethyl-N′-hydroxyethyl-bisaminoethylether and/or ethylenediamine. The tertiary amine catalysts can be further modified for use as delayed action catalysts by addition of approximately the same stoichiometric amount of acidic proton containing acid, such as phenols or formic acid. Such delayed action catalysts are commercially available from Air Products and Evonik.

The (E) catalyst may be utilized neat or disposed in a carrier vehicle. Carrier vehicles are known in the art and further described below as an optional component for the composition. If the carrier vehicle is utilized and solubilizes the (E) catalyst, the carrier vehicle may be referred to as a solvent. The carrier vehicle can be isocyanate-reactive, e.g. an alcohol-functional carrier vehicle, such as dipropylene glycol.

The (E) catalyst can be utilized in various amounts. One of skill in the art readily understands how to determine a suitable or catalytic amount of the (E) catalyst.

The composition may further comprise a chain extender. As readily understood in the art, chain extenders typically include two or more, but typically two, isocyanate-reactive groups (or active hydrogen atoms). These isocyanate-reactive groups are typically in the form of hydroxyl, primary amino, secondary amino, or mixtures of two or more of these groups. The term “active hydrogen atoms” refers to hydrogen atoms that, because of their placement in a molecule, display activity according to the Zerewitinoff test as described by Kohler in J. Am. Chemical Soc., 49, 31-81 (1927). When the chain extender is a diol, the resulting product is a polyurethane. When the chain extender is a diamine or an amino alcohol, the resulting product is a polyurea.

The chain extenders may be aliphatic, cycloaliphatic, or aromatic, and are exemplified by diols, diamines, and amino alcohols. Illustrative of the difunctional chain extenders are ethylene glycol, diethylene glycol, propylene glycol, dipropylene glycol, 1,3-propanediol, 1,3-butanediol, 1,4-butanediol, 1,5-pentanediol and other pentane diols, 2-ethyl-1,3-hexanediol, 2-ethyl-1,6-hexanediol, other 2-ethyl-hexanediols, 1,6-hexanediol and other hexanediols, 2,2,4-trimethylpentane-1,3-diol, decanediols, dodecanediols, bisphenol A, hydrogenated bisphenol A, 1,4-cyclohexanediol, 1,4-bis(2-hydroxyethoxy)-cyclohexane, 1,3-cyclohexanedimethanol, 1,4-cyclohexanediol, 1,4-bis(2-hydroxyethoxy)benzene, Esterdiol 204 (propanoic acid, 3-hydroxy-2,2-dimethylpropyl ester available from TCl America), N-methylethanolamine, N-methyl iso-propylamine, 4-aminocyclohexanol, 1,2-diaminotheane, 1,3-diaminopropane, diethylenetriamine, toluene-2,4-diamine, and toluene-1,6-diamine. Aliphatic compounds containing from 2 to 8 carbon atoms are most typical. Amine chain extenders include, but are not limited to, ethylenediamine, monomethanolamine, and propylenediamine.

Commonly used linear chain extenders are generally diol, diamine or amino alcohol compounds characterized by having a molecular weight of not more than 400 g/mol (or Dalton). In this context, by “linear,” it is meant that no branching from tertiary carbon is included. Examples of suitable chain extenders are represented by the following formulae: HO—(CH₂)ₜ—OH, H₂N—(CH₂)ₜ—NH₂, and H₂N—(CH₂)ₜ—OH, where subscript t is typically from 1 to 50.

One common chain extender is 1,4-butane diol (“butane diol” or “BDO”), and is represented by the following formula: HO—CH₂CH₂CH₂CH₂—OH. Other suitable chain extenders include ethylene glycol; diethylene glycol; 1,3-propanediol; 1,6-hexanediol; 1,5-heptanediol; triethyleneglycol; and combinations of two or more of these extenders.

Also suitable are cyclic chain extenders, which are generally diol, diamine or amino alcohol compounds, characterized by having a molecular weight of not more than 400 g/mol. In this context, by “cyclic” it is meant a ring structure, and typical ring structures include, but are not limited to, the 5 to 8 member ring structures with hydroxylalkyl branches.

In certain embodiments, the composition comprises the chain extender in an amount of from greater than 0 to 40, alternatively from 10 to 50, alternatively from 10 to 40, alternatively from 10 to 30, weight percent based on the total weight of the composition.

In certain embodiments, the composition further comprises a pH modifier or stabilizer. Specific examples thereof include diethylmalonate, alkylphenol alkylates, paratoluene sulfonic isocyanates, benzoyl chloride and orthoalkyl formates. When utilized, the pH modifier or stabilizer is typically present in the composition in an amount of from greater than 0 to 5, alternatively from greater than 0 to 4, alternatively from greater than 0 to 3, alternatively from greater than 0 to 2, alternatively from greater than 0 to 1, alternatively from greater than 0 to 0.8, alternatively from greater than 0 to 0.5, weight percent based on the total weight of the composition.

As introduced above, a urethane prepolymer comprising the reaction product of the composition is also disclosed. By urethane prepolymer, it is meant that the urethane prepolymer includes at least one urethane bond.

In certain embodiments, the urethane prepolymer is formed with a stoichiometric excess of isocyanate-functional groups in component (B) over the total amount of isocyanate-reactive groups of present in the composition, e.g. those in components (A) and (D), if utilized, as well as those present in the chain extender, if utilized. This can alternatively be referred to as reacting with an isocyanate index of greater than 100. In these embodiments, the urethane prepolymer is an isocyanate-functional prepolymer, having a backbone including both organic moieties from components (B) and (D), if utilized, and one or more siloxane moieties from component (A). Typically, in these embodiments, the isocyanate-reactive groups (i.e., OH groups of component (D), if present, and carbinol-functional groups of component (A)) are consumed in preparing the urethane prepolymer such that the urethane prepolymer does not include any isocyanate-reactive groups. The urethane prepolymer includes urethane bonds from the reaction between components (A) and (B) (and optionally between components (B) and (D)). In specific embodiments, the urethane prepolymer typically includes an average of at least two isocyanate-functional groups.

As one specific exemplary example, when the urethane prepolymer is formed with a stoichiometric excess of isocyanate-functional groups in component (B) over the total amount of isocyanate-reactive groups of present in the composition, when component (B) is 4,4′-MDI, when there is no (D) polyol or chain extender, and when component (A) is linear and includes a polyether functional group at each terminal, the urethane prepolymer may have the following formula, where x is from 0 to 100 and each y is independently from 1 to 50:

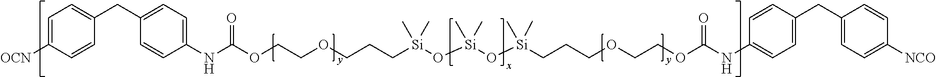

As another specific exemplary example, when the urethane prepolymer is formed with a stoichiometric excess of isocyanate-functional groups in component (B) over the total amount of isocyanate-reactive groups of present in the composition, when component (B) is 4,4′-MDI, when component (D) is present and is a polyether diol based on propylene oxide, and when component (A) is linear and includes a polyether functional group at each terminal, the urethane prepolymer may have the following formula:

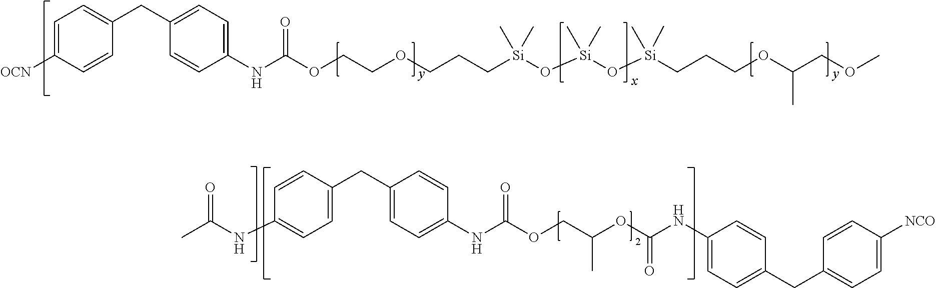

In another embodiment, the urethane prepolymer is formed with a stoichiometric equivalent of isocyanate-functional groups in component (B) and the total amount of isocyanate-reactive groups of present in the composition, e.g. those in components (A) and (D), if utilized, as well as those present in the chain extender, if utilized. In these embodiments, the resulting urethane prepolymer may include at least one isocyanate-functional group and at least one carbinol-functional group.

The composition alternatively be utilized to form a polyurethane instead of the urethane prepolymer. For example, the composition may be a polyurethane composition, where component (A) is utilized in combination with or in lieu of the polyol (D). In such embodiments, the composition may optionally further include an additive component. The additive component may be selected from the group of catalysts, plasticizers, cross-linking agents, chain-terminating agents, wetting agents, surface modifiers, surfactants, waxes, moisture scavengers, desiccants, viscosity reducers, reinforcing agents, dyes, pigments, colorants, flame retardants, mold release agents, anti-oxidants, compatibility agents, ultraviolet light stabilizers, thixotropic agents, anti-aging agents, lubricants, coupling agents, rheology promoters, thickeners, fire retardants, smoke suppressants, anti-static agents, anti-microbial agents, and combinations thereof.

One or more of the additives can be present as any suitable weight percent (wt. %) of the composition, such as 0.1 wt. % to 15 wt. %, 0.5 wt. % to 5 wt. %, or 0.1 wt. % or less, 1 wt. %, 2, 3, 4, 5, 6, 7, 8, 9, 10, 11, 12, 13, 14, or 15 wt. % or more of the composition. One of skill in the art can readily determine a suitable amount of additive depending, for example, on the type of additive and the desired outcome. Certain optional additives are described in greater detail below.

The urethane prepolymer is particularly suited for various end use applications in curable compositions. For example, the urethane prepolymer may be utilized in an adhesive, which is also provided by this disclosure.

The adhesive can comprise the urethane prepolymer in an amount of from greater than 10 to 60, alternatively from 20 to 50, alternatively from 20 to 40, weight percent based on the total weight of the adhesive.

The adhesive typically further comprises (F) a filler.

The (F) filler may be untreated, pretreated, or added in conjunction with an optional filler treating agent, described below, which when so added may treat the (F) filler in situ and/or prior to use. The (F) filler may be a single filler or a combination of two or more fillers that differ in at least one property such as type of filler, method of preparation, treatment or surface chemistry, filler composition, filler shape, filler surface area, average particle size, and/or particle size distribution.

The shape and dimensions of the (F) filler is also not specifically restricted. For example, the (F) filler may be spherical, rectangular, ovoid, irregular, and may be in the form of, for example, a powder, a flour, a fiber, a flake, a chip, a shaving, a strand, a scrim, a wafer, a wool, a straw, a particle, and combinations thereof. Dimensions and shape are typically selected based on the type of the (F) filler utilized, and an end use application of the adhesive. In certain embodiments, the (F) filler has an average particle size or average largest dimension of from greater than 0 to 500, alternatively from greater than 0 to 450, alternatively from greater than 0 to 400, alternatively from greater than 0 to 350, alternatively from greater than 0 to 300, alternatively from greater than 0 to 250, alternatively from greater than 0 to 200, alternatively from greater than 0 to 150, alternatively from greater than 0 to 100, microns. In other embodiments, the (F) filler has an average particle size or average largest dimension of from greater than 0 to 500, alternatively from greater than 0 to 450, alternatively from greater than 0 to 400, alternatively from greater than 0 to 350, alternatively from greater than 0 to 300, alternatively from greater than 0 to 250, alternatively from greater than 0 to 200, alternatively from greater than 0 to 150, alternatively from greater than 0 to 100, nanometers. Methods of measuring average particle size are known in the art, e.g. via light scattering techniques, such as dynamic light scattering.

Non-limiting examples of fillers that may function as reinforcing fillers include reinforcing silica fillers such as fume silica, silica aerogel, silica xerogel, and precipitated silica. Fumed silicas are known in the art and commercially available; e.g., fumed silica sold under the name CAB-O-SIL by Cabot Corporation of Massachusetts, U.S.A.

Non-limiting examples fillers that may function as extending or reinforcing fillers include quartz and/or crushed quartz, aluminum oxide, magnesium oxide, silica (e.g. fumed, ground, precipitated), hydrated magnesium silicate, magnesium carbonate, dolomite, silicone resin, wollastonite, soapstone, kaolinite, kaolin, mica muscovite, phlogopite, halloysite (hydrated alumina silicate), aluminum silicate, sodium aluminosilicate, glass (fiber, beads or particles, including recycled glass, e.g. from wind turbines or other sources), clay, magnetite, hematite, calcium carbonate such as precipitated, fumed, and/or ground calcium carbonate, calcium sulfate, barium sulfate, calcium metasilicate, zinc oxide, talc, diatomaceous earth, iron oxide, clays, mica, chalk, titanium dioxide (titania), zirconia, sand, carbon black, graphite, anthracite, coal, lignite, charcoal, activated carbon, non-functional silicone resin, alumina, silver, metal powders, magnesium oxide, magnesium hydroxide, magnesium oxysulfate fiber, aluminum trihydrate, aluminum oxyhydrate, coated fillers, carbon fibers (including recycled carbon fibers, e.g. from the aircraft and/or automotive industries), poly-aramids such as chopped KEVLAR™ or Twaron™, nylon fibers, mineral fillers or pigments (e.g. titanium dioxide, non-hydrated, partially hydrated, or hydrated fluorides, chlorides, bromides, iodides, chromates, carbonates, hydroxides, phosphates, hydrogen phosphates, nitrates, oxides, and sulfates of sodium, potassium, magnesium, calcium, and barium; zinc oxide, antimony pentoxide, antimony trioxide, beryllium oxide, chromium oxide, lithopone, boric acid or a borate salt such as zinc borate, barium metaborate or aluminum borate, mixed metal oxides such as vermiculite, bentonite, pumice, perlite, fly ash, clay, and silica gel; rice hull ash, ceramic and, zeolites, metals such as aluminum flakes or powder, bronze powder, copper, gold, molybdenum, nickel, silver powder or flakes, stainless steel powder, tungsten, barium titanate, silica-carbon black composite, functionalized carbon nanotubes, cement, slate flour, pyrophyllite, sepiolite, zinc stannate, zinc sulphide), and combinations thereof. Alternatively, the extending or reinforcing filler may be selected from the group consisting of calcium carbonate, talc and a combination thereof.

Extending fillers are known in the art and commercially available; such as a ground silica sold under the name MIN-U-SIL by U.S. Silica of Berkeley Springs, WV. Suitable precipitated calcium carbonates include Winnofil™ SPM from Solvay and Ultra-Pflex™ and Ultra-Pflex™ 100 from SMI.

Alternatively, the (F) filler can be selected from the group consisting of aluminum nitride, aluminum oxide, aluminum trihydrate, aluminum oxyhydrate, barium titanate, barium sulfate, beryllium oxide, carbon fibers, diamond, graphite, magnesium hydroxide, magnesium oxide, magnesium oxysulfate fiber, metal particulate, onyx, silicon carbide, tungsten carbide, zinc oxide, coated fillers, and a combination thereof.

Metallic fillers include particles of metals, metal powders, and particles of metals having layers on the surfaces of the particles. These layers may be, for example, metal nitride layers or metal oxide layers. Suitable metallic fillers are exemplified by particles of metals selected from the group consisting of aluminum, copper, gold, nickel, silver, and combinations thereof, and alternatively aluminum. Suitable metallic fillers are further exemplified by particles of the metals listed above having layers on their surfaces selected from the group consisting of aluminum nitride, aluminum oxide, copper oxide, nickel oxide, silver oxide, and combinations thereof. For example, the metallic filler may comprise aluminum particles having aluminum oxide layers on their surfaces. Inorganic fillers are exemplified by onyx; aluminum trihydrate, aluminum oxyhydrate, metal oxides such as aluminum oxide, beryllium oxide, magnesium oxide, and zinc oxide; nitrides such as aluminum nitride; carbides such as silicon carbide and tungsten carbide; and combinations thereof. Alternatively, inorganic fillers are exemplified by aluminum oxide, zinc oxide, and combinations thereof.

Alternatively, the (F) filler may comprise a non-reactive silicone resin. For example, the (F) filler may comprise a non-reactive MQ silicone resin. As known in the art, M siloxy units are represented by R⁰₃SiO_{1/2}, and Q siloxy units are represented by SiO_{4/2}, where R⁰ is an independently selected substituent. Such non-reactive silicone resins are typically soluble in liquid hydrocarbons such as benzene, toluene, xylene, heptane and the like or in liquid organosilicon compounds such as a low viscosity cyclic and linear polydiorganosiloxanes. The molar ratio of M to Q siloxy units in the non-reactive silicone resin may be from 0.5/1 to 1.5/1, alternatively from 0.6/1 to 0.9/1. The non-reactive silicone resin may further comprise 2.0 wt. % or less, alternatively 0.7 wt. % or less, alternatively 0.3 wt. % or less, of T units including a silicon-bonded hydroxyl or a hydrolyzable group, exemplified by alkoxy such as methoxy and ethoxy, and acetoxy, while still being within the scope of such non-reactive silicone resins. The concentration of hydrolyzable groups present in the non-reactive silicone resin can be determined using Fourier Transform-Infrared (FT-IR) spectroscopy.

Alternatively or in addition, the (F) filler may comprise a non-reactive silicone resin other than the non-reactive MQ silicone resin described immediately above. For example, the (F) filler may comprise a T resin, a TD resin, a TDM resin, a TDMQ resin, or any other non-reactive silicone resin. Typically, such non-reactive silicone resins include at least 30 mole percent T siloxy and/or Q siloxy units. As known in the art, D siloxy units are represented by R⁰₂SiO_{2/2}, and T siloxy units are represented by R⁰SiO_{3/2}, where R⁰ is an independently selected substituent.

The weight average molecular weight, Mw, of the non-reactive silicone resin will depend at least in part on the molecular weight of the silicone resin and the type(s) of substituents (e.g. hydrocarbyl groups) that are present in the non-reactive silicone resin. Mw as used herein represents the weight average molecular weight measured using conventional gel permeation chromatography (GPC), with narrow molecular weight distribution polystyrene (PS) standard calibration, when the peak representing the neopentamer is excluded from the measurement. The PS equivalent Mw of the non-reactive silicone resin may be from 12,000 to 30,000 g/mole, typically from 17,000 to 22,000 g/mole. The non-reactive silicone resin can be prepared by any suitable method. Silicone resins of this type have been prepared by cohydrolysis of the corresponding silanes or by silica hydrosol capping methods generally known in the art.

Regardless of the selection of the (F) filler, the (F) filler may be untreated, pretreated, or added to form the adhesive in conjunction with an optional filler treating agent, which when so added may treat the (F) filler in situ in the adhesive.

The filler treating agent may comprise a silane such as an alkoxysilane, an alkoxy-functional oligosiloxane, a cyclic polyorganosiloxane, a hydroxyl-functional oligosiloxane such as a dimethyl siloxane or methyl phenyl siloxane, an organosilicon compound, a stearate, or a fatty acid. The filler treating agent may comprise a single filler treating agent, or a combination of two or more filler treating agents selected from similar or different types of molecules.

The filler treating agent may comprise an alkoxysilane, which may be a mono-alkoxysilane, a di-alkoxysilane, a tri-alkoxysilane, or a tetra-alkoxysilane. Alkoxysilane filler treating agents are exemplified by hexyltrimethoxysilane, octyltriethoxysilane, decyltrimethoxysilane, dodecyltrimethoxysilane, tetradecyltrimethoxysilane, phenyltrimethoxysilane, phenylethyltrimethoxysilane, octadecyltrimethoxysilane, octadecyltriethoxysilane, and a combination thereof. In certain aspects the alkoxysilane(s) may be used in combination with silazanes, which catalyze the less reactive alkoxysilane reaction with surface hydroxyls. Such reactions are typically performed above 100° C. with high shear with the removal of volatile by-products such as ammonia, methanol and water.

Suitable filler treating agents also include alkoxysilyl functional alkylmethyl polysiloxanes, or similar materials where the hydrolyzable group may comprise, for example, silazane, acyloxy or oximo.

Alkoxy-functional oligosiloxanes can also be used as filler treating agents. Alkoxy-functional oligosiloxanes and methods for their preparation are generally known in the art. Other filler treating agents include mono-endcapped alkoxy functional polydiorganosiloxanes, i.e., polyorganosiloxanes having alkoxy functionality at one end.

Alternatively, the filler treating agent can be any of the organosilicon compounds typically used to treat silica fillers. Examples of organosilicon compounds include organochlorosilanes such as methyltrichlorosilane, dimethyldichlorosilane, and trimethyl monochlorosilane; organosiloxanes such as hydroxy-endblocked dimethylsiloxane oligomer, silicon hydride functional siloxanes, hexamethyldisiloxane, and tetramethyldivinyldisiloxane; organosilazanes, such as hexamethyldisilazane and hexamethylcyclotrisilazane; and organoalkoxysilanes such as alkylalkoxysilanes with methyl, propyl, n-butyl, i-butyl, n-hexyl, n-octyl, i-octyl, n-decyl, dodecyl, tetradecyl, hexadecyl, or octadecyl substituents. Organoreactive alkoxysilanes can include amino, methacryloxy, vinyl, glycidoxy, epoxycyclohexyl, isocyanurato, isocyanato, mercapto, sulfido, vinyl-benzyl-amino, benzyl-amino, or phenyl-amino substituents. Alternatively, the (F) filler treating agent may comprise an organopolysiloxane. The use of such a filler treating agent to treat the surface of the (F) filler may take advantage of multiple hydrogen bonds, either clustered or dispersed or both, as the method to bond the organosiloxane to the surface of the (F) filler. The organosiloxane capable of hydrogen bonding has an average, per molecule, of at least one silicon-bonded group capable of hydrogen bonding. The group may be selected from a monovalent organic group having multiple hydroxyl functionalities or a monovalent organic group having at least one amino functional group. Hydrogen bonding may be a primary mode of bonding of the filler treating agent to the (F) filler. The filler treating agent may be incapable of forming covalent bonds with the (F) filler. The filler treating agent capable of hydrogen bonding may be selected from the group consisting of a saccharide-siloxane polymer, an amino-functional organosiloxane, and a combination thereof. Alternatively, the filler treating agent capable of hydrogen bonding may be a saccharide-siloxane polymer.

Alternatively, the filler treating agent may comprise alkylthiols such as octadecyl mercaptan and others, and fatty acids such as oleic acid, stearic acid, titanates, titanate coupling agents, zirconate coupling agents, and a combination thereof. One skilled in the art could optimize a filler treating agent to aid dispersion of the (F) filler without undue experimentation.

If utilized, the relative amount of the filler treatment agent and the (F) filler is selected based on the particular filler utilized as well as the filler treatment agent, and desired effect or properties thereof. Combinations of different fillers and/or filler treating agents may also be utilized.

The amount of the (F) filler utilized, if at all, is a function of many variables. In certain embodiments, the adhesive comprises the filler in an amount of from 20 to 70, alternatively 30 to 60, wt. % based on the total weight of the adhesive.

In certain embodiments, the adhesive further comprises a (G) catalyst for promoting reactions between isocyanate-functionality of the urethane prepolymer and atmospheric moisture such that the reaction between occurs when the adhesive is exposed to ambient moisture, e.g. when dispensed from a can or cylinder. Examples of such (G) catalysts include amine catalysts, metal complexes, or combinations thereof. Amine catalysts may include organic compounds that contain at least one tertiary nitrogen atom (e.g., a tertiary amine). Examples include amidines or guanidines, such as for example, 4-diazabicyclo[2.2.2]octane (DABCO), 1,8-diazabicyclo[5.4.0]undec-7-ene (DBU), triethylenediamine, tetramethylethylenediamine, pentamethyldiethylene triamine, bis(2-dimethylaminoethyl)ether, triethylamine, tripropylamine, tributylamine, triamylamine, pyridine, quinoline, dimethylpiperazine, piperazine, N,N-dimethylcyclohexylamine, N-ethyl-morpholine, 2,2′-dimorpholinodiethylether (“DMDEE”), 2-methylpropanediamine, methyltriethylenediamine, 2,4,6-tri(dimethylamino methyl)phenol, N,N′,N″-tris(dimethylamino-propyl)sym-hexahydrotriazine, and mixtures thereof. In further embodiments, the amine catalyst comprises bis(2-dimethylamino-ethyl)ether, dimethylcyclohexylamine, N,N-dimethyl-ethanolamine, triethylenediamine, triethylamine, 2,4,6-tri(dimethylaminomethyl)phenol, N,N′,N-ethylmorpholine, organometadic catalysts based on tin, zinc and bismuth, for example dibutyltin dilaurate and/or mixtures thereof.

In some embodiments, the adhesive comprises (H) a plasticizer. Examples of suitable (H) plasticizers include organic plasticizers, such as those comprising a carboxylic acid ester (e.g. esters), a phthalate (e.g. phthalates), a carboxylate (e.g. carboxylates), an adipate (e.g. adipates), or a combination thereof. Specific examples of suitable organic plasticizers include bis(2-ethylhexyl)terephthalate, bis(2-ethylhexyl)-1,4-benzenedicarboxylate, 2-ethylhexyl methyl-1,4-benzenedicarboxylate, 1,2 cyclohexanedicarboxylic acid, dinonyl ester (branched and linear), bis(2-propylheptyl)phthalate, diisononyl adipate, and combinations thereof.

In certain embodiments, the (H) plasticizer is an ester having an average, per molecule, of at least one group of formula:

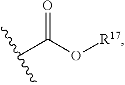

where R¹⁷ represents a hydrogen atom or a monovalent organic group (e.g. a branched or linear monovalent hydrocarbon group, such as an alkyl group of 4 to 15 carbon atoms, alternatively 9 to 12 carbon atoms). In these or other embodiments, the plasticizer has an average, per molecule, of at least two groups of the formula above each bonded to carbon atoms in a cyclic hydrocarbon. In such instances, the plasticizer may have general formula:

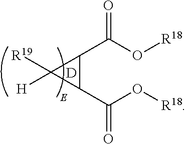

In this formula, D is a carbocyclic group having 3 or more carbon atoms, alternatively 3 to 15 carbon atoms, which may be unsaturated, saturated, or aromatic. Subscript E is from 1 to 12. Each R¹⁸ is independently a branched or linear monovalent hydrocarbon group, such as an alkyl group of 4 to 15 carbon atoms (e.g. an alkyl group such as methyl, ethyl, butyl, etc.). Each R¹⁹ is independently a hydrogen atom or a branched or linear, substituted or unsubstituted, monovalent organic group. For example, in some embodiments, at least one R¹⁹ is a moiety comprising an ester functional group.

In specific embodiments, the adhesive comprises a polymeric plasticizer. Examples of polymeric plasticizers include alkenyl polymers (e.g. those obtained by polymerizing vinyl or allyl monomers via various methods); polyalkylene glycol esters (e.g. diethylene glycol dibenzoates, triethylene glycols, dibenzoate pentaerythritol esters, etc.); polyester plasticizers (e.g. those obtained from dibasic acids such as sebacic acid, adipic acid, azelaic acid, phthalic acid, etc. and dihydric alcohols such as ethylene glycol, diethylene glycol, triethylene glycol, propylene glycol, dipropylene glycol, etc.); polyethers including polyether polyols each having a molecular weight of not less than 500 (e.g. polyethylene glycols, polypropylene glycols, polytetramethylene glycols, etc.); polystyrenes (e.g. polystyrene, poly-alpha-methylstyrene, etc.); polybutenes and polybutadienes (e.g. polyisobutylene, butadiene acrylonitrile, etc.); and polychloroprenes. In various embodiments, a low molecular weight plasticizer and a higher molecular weight polymeric plasticizer may present in the adhesive in combination.

Specific plasticizers are known in the art and are commercially available. Such plasticizers may be present in the adhesive alone or in combination. For example, the plasticizer may comprise a phthalate, such as: a dialkyl phthalate such as dibutyl phthalate (Eastman™ DBP Plasticizer), diheptyl phthalate, diisononyl phthalate, di(2-ethylhexyl) phthalate, or diisodecyl phthalate (DIDP), bis(2-propylheptyl) phthalate (BASF Palatinol™ DPHP), di(2-ethylhexyl) phthalate (Eastman™ DOP Plasticizer), dimethyl phthalate (Eastman™ DMP Plasticizer); diethyl phthalate (Eastman™ DMP Plasticizer); butyl benzyl phthalate, and bis(2-ethylhexyl)terephthalate (Eastman™ 425 Plasticizer); a dicarboxylate such as Benzyl, C₇-C₉ linear and branched alkyl esters, 1, 2, benzene dicarboxylic acid (Ferro SANTICIZER™ 261A), 1,2,4-benzenetricarboxylic acid (BASF Palatinol™ TOTM-I), bis(2-ethylhexyl)-1,4-benzenedicarboxylate (Eastman™ 168 Plasticizer); 2-ethylhexyl methyl-1,4-benzenedicarboxylate; 1,2 cyclohexanedicarboxylic acid, dinonyl ester, branched and linear (BASF Hexamoll™ DINCH); diisononyl adipate; trimellitates such as trioctyl trimellitate (Eastman™ TOTM Plasticizer); triethylene glycol bis(2-ethylhexanoate) (Eastman™ TEG-EH Plasticizer); triacetin (Eastman™ Triacetin); nonaromatic dibasic acid esters such as dioctyl adipate, bis(2-ethylhexyl)adipate (Eastman™ DOA Plasticizer and Eastman™ DOA Plasticizer, Kosher), di-2-ethylhexyladipate (BASF Plastomoll™ DOA), dioctyl sebacate, dibutyl sebacate and diisodecyl succinate; aliphatic esters such as butyl oleate and methyl acetyl recinolate; phosphates such as tricresyl phosphate and tributyl phosphate; chlorinated paraffins; hydrocarbon oils such as alkyldiphenyls and partially hydrogenated terphenyls; process oils; epoxy plasticizers such as epoxidized soybean oil and benzyl epoxystearate; tris(2-ethylhexyl)ester; a fatty acid ester; and a combination thereof. Examples of other suitable plasticizers and their commercial sources include BASF Palamoll™ 652 and Eastman 168 Xtreme™ Plasticizer.

The amount of the (H) plasticizer present in the adhesive depends on various factors (e.g. the amount and/or type of the at least one silicone-polyether copolymer, the types and/or amounts of any additional materials present in the adhesive (such as other polymer additives), the type of crosslinker utilized, etc.), and may be readily determined by one of skill in the art. In general, where present, the adhesive comprises the plasticizer in an amount of from greater than 0 to 20 alternatively from 5 to 15, weight percent based on the total weight of the adhesive.

In certain embodiments, the adhesive further comprises (I) an adhesion promoter. Suitable (I) adhesion promoters may comprise a hydrocarbonoxysilane such as an alkoxysilane, a combination of an alkoxysilane and a hydroxy-functional polyorganosiloxane, an amino functional silane, an epoxy functional silane, a mercaptofunctional silane, or a combination thereof. Adhesion promoters are known in the art and may comprise silanes having the formula R⁵_{f}R⁶_{g}Si(OR⁷)_{4-(f+g)} where each R⁵ is independently a monovalent organic group having at least 3 carbon atoms; R⁶ contains at least one SiC bonded substituent having an adhesion-promoting group, such as amino, epoxy, mercapto or acrylate groups; each R⁷ is independently a monovalent organic group (e.g. methyl, ethyl, propyl, butyl, etc.); subscript f has a value ranging from 0 to 2; subscript g is either 1 or 2; and the sum of (f+g) is not greater than 3. In certain embodiments, the (I) adhesion promoter comprises a partial condensate of the above silane. In these or other embodiments, the (I) adhesion promoter comprises a combination of an alkoxysilane and a hydroxy-functional polyorganosiloxane.

In some embodiments, the (I) adhesion promoter comprises an unsaturated or epoxy-functional compound. In such embodiments, the (I) adhesion promoter may be or comprise an unsaturated or epoxy-functional alkoxysilane such as those having the formula (XIII): R⁸ₕSi(OR⁹)₍₄₋ₕ₎, where subscript h is 1, 2, or 3, alternatively subscript h is 1. Each R⁸ is independently a monovalent organic group with the proviso that at least one R⁸ is an unsaturated organic group or an epoxy-functional organic group. Epoxy-functional organic groups for R⁸ are exemplified by 3-glycidoxypropyl and (epoxycyclohexyl)ethyl. Unsaturated organic groups for R⁸ are exemplified by 3-methacryloyloxypropyl, 3-acryloyloxypropyl, and unsaturated monovalent hydrocarbon groups such as vinyl, allyl, hexenyl, undecylenyl. Each R⁹ is independently a saturated hydrocarbon group of 1 to 4 carbon atoms, alternatively 1 to 2 carbon atoms. R⁹ is exemplified by methyl, ethyl, propyl, and butyl.

Specific examples of suitable epoxy-functional alkoxysilanes include 3-glycidoxypropyltrimethoxysilane, 3-glycidoxypropyltriethoxysilane, (epoxycyclohexyl)ethyldimethoxysilane, (epoxycyclohexyl)ethyldiethoxysilane and combinations thereof. Examples of suitable unsaturated alkoxysilanes include vinyltrimethoxysilane, allyltrimethoxysilane, allyltriethoxysilane, hexenyltrimethoxysilane, undecylenyltrimethoxysilane, 3-methacryloyloxypropyl trimethoxysilane, 3-methacryloyloxypropyl triethoxysilane, 3-acryloyloxypropyl trimethoxysilane, 3-acryloyloxypropyl triethoxysilane, and combinations thereof.

In some embodiments, the (I) adhesion promoter comprises an epoxy-functional siloxane, such as a reaction product of a hydroxy-terminated polyorganosiloxane with an epoxy-functional alkoxysilane (e.g. such as one of those described above), or a physical blend of the hydroxy-terminated polyorganosiloxane with the epoxy-functional alkoxysilane. The (I) adhesion promoter may comprise a combination of an epoxy-functional alkoxysilane and an epoxy-functional siloxane. For example, the (I) adhesion promoter is exemplified by a mixture of 3-glycidoxypropyltrimethoxysilane and a reaction product of hydroxy-terminated methylvinylsiloxane with 3-glycidoxypropyltrimethoxysilane, or a mixture of 3-glycidoxypropyltrimethoxysilane and a hydroxy-terminated methylvinylsiloxane, or a mixture of 3-glycidoxypropyltrimethoxysilane and a hydroxy-terminated methylvinyl/dimethylsiloxane copolymer.

In certain embodiments, the (I) adhesion promoter comprises an aminofunctional silane, such as an aminofunctional alkoxysilane exemplified by H₂N(CH₂)₂Si(OCH₃)₃, H₂N(CH₂)₂Si(OCH₂CH₃)₃, H₂N(CH₂)₃Si(OCH₃)₃, H₂N(CH₂)₃Si(OCH₂CH₃)₃, CH₃NH(CH₂)₃Si(OCH₃)₃, CH₃NH(CH₂)₃Si(OCH₂CH₃)₃, CH₃NH(CH₂)₅Si(OCH₃)₃, CH₃NH(CH₂)₅Si(OCH₂CH₃)₃, H₂N(CH₂)₂NH(CH₂)₃Si(OCH₃)₃, H₂N(CH₂)₂NH(CH₂)₃Si(OCH₂CH₃)₃, CH₃NH(CH₂)₂NH(CH₂)₃Si(OCH₃)₃, CH₃NH(CH₂)₂NH(CH₂)₃Si(OCH₂CH₃)₃, C₄H₉NH(CH₂)₂NH(CH₂)₃Si(OCH₃)₃, C₄H₉NH(CH₂)₂NH(CH₂)₃Si(OCH₂CH₃)₃, H₂N(CH₂)₂SiCH₃(OCH₃)₂, H₂N(CH₂)₂SiCH₃(OCH₂CH₃)₂, H₂N(CH₂)₃SiCH₃(OCH₃)₂, H₂N(CH₂)₃SiCH₃(OCH₂CH₃)₂, CH₃NH(CH₂)₃SiCH₃(OCH₃)₂, CH₃NH(CH₂)₃SiCH₃(OCH₂CH₃)₂, CH₃NH(CH₂)₅SiCH₃(OCH₃)₂, CH₃NH(CH₂)₅SiCH₃(OCH₂CH₃)₂, H₂N(CH₂)₂NH(CH₂)₃SiCH₃(OCH₃)₂, H₂N(CH₂)₂NH(CH₂)₃SiCH₃(OCH₂CH₃)₂, CH₃NH(CH₂)₂NH(CH₂)₃SiCH₃(OCH₃)₂, CH₃NH(CH₂)₂NH(CH₂)₃SiCH₃(OCH₂CH₃)₂, C₄H₉NH(CH₂)₂NH(CH₂)₃SiCH₃(OCH₃)₂, C₄H₉NH(CH₂)₂NH(CH₂)₃SiCH₃(OCH₂CH₃)₂, N-(3-(trimethoxysilyl)propyl)ethylenediamine, and the like, as well as combinations thereof. In these or other embodiments, the (I) adhesion promoter comprises a mercaptofunctional alkoxysilane, such as 3-mercaptopropyltrimethoxysilane or 3-mercaptopropyltriethoxysilane.

Additional examples of adhesion promoters are the reaction producst of an epoxyalkylalkoxysilane, such as 3-glycidoxypropyltrimethoxysilane, and an amino-substituted alkoxysilane, such as 3-aminopropyltrimethoxysilane, optionally with an alkylalkoxysilane, such as methyltrimethoxysilane.

The amount of the (I) adhesion promoter in the adhesive depends on various factors (e.g. the amount and/or type urethane prepolymer, the types and/or amounts of any additional materials present in the adhesive, curing conditions to which the adhesive is intended to be exposed, etc.), and may be readily determined by one of skill in the art. In general, where present, the adhesive comprises the (I) adhesion promoter in an amount of from 0.01 to 10, alternatively from 0.01 to 5, alternatively from 0.01 to 2.5, weight percent based on the total weight of the adhesive.

In certain embodiments, the adhesive comprises a drying agent, such as physical drying agents (e.g. adsorbents), chemical drying agents, etc. In general, the drying agent binds water and low-molecular weight alcohol from various sources. For example, the drying agent may bind by-products of a condensation reaction involving the at least one silicone-polyether copolymer, such as water and alcohols. Physical drying agents typically trap and/or adsorb such water and/or by-products, where chemical drying agents typically binding the water and/or other by-products by chemical means (e.g. via covalent bonding). Examples of suitable drying agents for use in the adhesive include adsorbents, such as those comprising inorganic particulates. Such adsorbents typically have a particle size of 10 micrometers or less, alternatively 5 micrometers or less, and an average pore size sufficient to adsorb water and low-molecular weight alcohol alcohols (e.g. an average pore size of 10 Å (Angstroms) or less, alternatively 5 Å or less, alternatively 3 Å or less). Specific examples of such adsorbents include zeolites (e.g. chabasite, mordenite, and analcite) and molecular sieves comprising alkali metal alumino silicates, silica gel, silica-magnesia gel, activated carbon, activated alumina, calcium oxide, and combinations thereof. Examples of commercially available drying agents include dry molecular sieves, such as 3 Å (Angstrom) molecular sieves sold under the trademark SYLOSIV™ by Grace Davidson and under the trade name PURMOL by Zeochem of Louisville, Ky., U.S.A., and 4 Å molecular sieves sold under the trade name Doucil zeolite 4A by Ineos Silicas of Warrington, England. Other examples of suitable drying agents include: MOLSIV ADSORBENT TYPE 13X, 3A, 4A, and 5A molecular sieves, all of which are commercially available from UOP of Illinois, U.S.A.; SILIPORITE NK 30AP and 65xP molecular sieves from Atofina of Philadelphia, Pa., U.S.A.; and molecular sieves available from W.R. Grace of Maryland, U.S.A. under various names. Examples of chemical drying agents include silanes, such as those described above with respect to the crosslinker. For example, alkoxysilanes suitable as drying agents include vinyltrimethoxysilane, vinyltriethoxysilane, and combinations thereof. As understood by those of skill in the art, the chemical drying agent may be added to the adhesive, or to a part of the adhesive (e.g. where the adhesive is a multiple-part composition) to keep the adhesive or part thereof free from water. As such, the drying agent may be added to a part (e.g. a dry part) of the adhesive prior to the adhesive being formed, thereby rendering the part shelf stable. Alternatively, or additionally, the drying agent may keep the adhesive free from water after formulation (e.g. after the parts of the adhesive are combined/mixed together). The amount of the drying agent present in the adhesive depends on various factors (e.g. the amount and/or type of the at least one silicone-polyether copolymer, the types and/or amounts of any additional materials present in the adhesive, curing conditions to which the adhesive is intended to be exposed, etc.), and may be readily determined by one of skill in the art. In general, where present, the adhesive comprises the drying agent in an amount of from 0.1 to 5 parts by weight, based on the combined weights of all components in the adhesive.

In certain embodiments, the adhesive comprises a rheology additive, such as a rheology modifier and/or a viscosity modifier. Examples of suitable rheological additives include waxes; polyamides; polyamide waxes; hydrogenated castor oil derivatives; metal soaps, such as calcium, aluminum, and/or barium stearates; and the like, as well as derivatives, modifications, and combinations thereof. In particular embodiments, the rheology modifier is selected to facilitate incorporation of fillers, compounding, de-airing, and/or mixing of the adhesive (e.g. during preparation thereof), as well understood by those of skill in the art. Specific examples of rheological additives include those known in the art which are commercially available. Examples of such rheological additives include Polyvest, which is commercially available from Evonik; Disparlon which is commercially available from King Industries; Kevlar Fibre Pulp, which is commercially available from Du Pont; Rheospan which is commercially available from Nanocor; Ircogel, which is commercially available from Lubrizol; Crayvallac™ SLX, which is commercially available from Palmer Holland, and the like, as well as combinations thereof.

The amount of the rheological additive present in the adhesive depends on various factors (e.g. the amount and/or type of the urethane prepolymer, an intended use of the adhesive, curing conditions to which the adhesive is intended to be exposed, a presence/absence of a vehicle/solvent, etc.), and may be readily determined by one of skill in the art. In general, where present, the adhesive comprises the rheological additive in an amount of from greater than 0 to 20, alternatively from 1 to 15, alternatively from 1 to 5, parts by weight, based on the combined weights of all components in the adhesive.

The adhesive may optionally further include an additive component. The additive component may be selected from the group of cross-linking agents, chain-terminating agents, wetting agents, surface modifiers, surfactants, waxes, dyes, pigments, colorants, flame retardants, mold release agents, anti-oxidants, compatibility agents, ultraviolet light stabilizers, thixotropic agents, anti-aging agents, lubricants, coupling agents, fire retardants, smoke suppressants, anti-static agents, anti-microbial agents, and combinations thereof.

One or more of the additives can be present as any suitable weight percent (wt. %) of the adhesive, such as 0.1 wt. % to 15 wt. %, 0.5 wt. % to 5 wt. %, or 0.1 wt. % or less, 1 wt. %, 2, 3, 4, 5, 6, 7, 8, 9, 10, 11, 12, 13, 14, or 15 wt. % or more of the adhesive. One of skill in the art can readily determine a suitable amount of additive depending, for example, on the type of additive and the desired outcome.

The adhesive may be prepared by combining the components in any order of addition, optionally under shear. The adhesive can be prepared in situ in an end use application, i.e., the components may be combined during an end use application of the adhesive, or may be formed and subsequently utilized. If desired, at least one condition may be selectively modified during formation of the adhesive, e.g. temperature, humidity, pressure, etc. The adhesive can be a one component, two component, or multi-component system. Additional aspects of how to prepare and use adhesives are disclosed in International PCT Application No. PCT/US2020/012182, which is incorporated by reference herein.

### EXAMPLES

The following examples are intended to illustrate the invention and are not to be viewed in any way as limiting to the scope of the invention.

Certain components utilized in the Examples are set forth in Table 1 below.

TABLE 1
Components/Compounds Utilized

| Abbreviation | Meaning/ Definition |
|---|---|
| Alkenyl-functional Siloxane | A vinyldimethylsiloxy-terminated polydimethylsiloxane |
| | having a degree of polymerization (DP) of 16. |
| Carbinol-functional Siloxane | 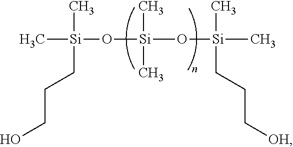 |
| | where n is 16 |
| Polyether-functional Siloxane | 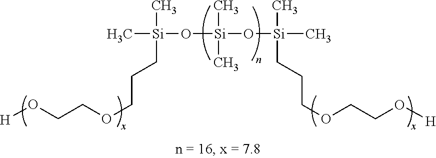 |
| Comparative Polyether- functional Siloxane Composition | 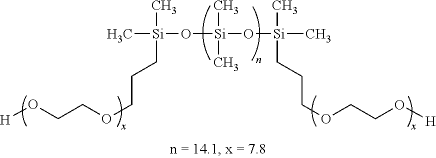 |
| | as made via hydrosilylation including 31.8 mol % |
| | residual allyl-terminated polyether compounds. |
| Ligand | 6,6′-[3,3′,5,5′-tetrakis(1,1-dimethylethyl)-1,1′-biphenyl]- |
| | 2,2′-diyl]bis(oxy)]bis-dibenzo[d,f] |
| | [1,3,2]dioxaphosphepin prepared as described in U.S. |
| | Patent No. 10,227,365 to Miller, et al. |
| FAB | tris(pentafluorophenyl)borane |
| Polyol 1 | Polypropylene glycol diol having a Mₙ of ~ 2,000 |
| Polyol 2 | Polypropylene glycol triol, capped, having a Mₙ of ~ 6,000 |
| Isocyanate 1 | A 50/50 blend of 4-4′-diphenylmethane diisocyanate |
| | and 2,4′-diphenylmethane diisocyanate |
| Catalyst 1 | 97 wt. % stannous octoate in 2-ethylhexanoic acid |
| Isocyanate-functional | As prepared in Example 1 |
| prepolymer | |
| Comparative Isocyanate- | As prepared in Comparative Example 1 |
| functional prepolymer | |

### General Procedure for Preparation of Raney Ni Active Catalyst

50 wt. % Raney Ni™ in water was purchased and washed several times using deionized water in a plastic funnel. Special care was taken to ensure that the catalyst was always immersed in water (as Raney Ni™ is highly pyrophoric). Then, the water was exchanged with isopropanol (IPA) by gradual siphoning of the water via vacuum while adding the IPA. The catalyst was further washed with IPA several times and transferred in a glass bottle as a suspension as a Raney Ni active catalyst.

### General Procedure for the Hydroformylation/Hydrogenation One Pot Reaction

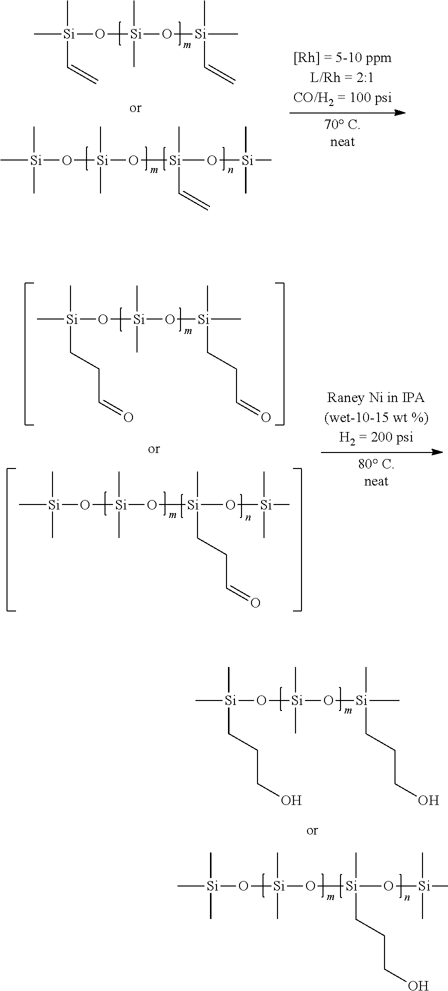

### General Reaction Scheme for the Hydroformylation/Hydrogenation One Pot Reaction

In a nitrogen filled glove box, a stock solution of catalyst was prepared with Rh(acac)(CO)₂ (8.2 mg), Ligand (53 mg) and toluene (130 g) which were weighed into a 200 mL glass bottle. A desired quantity from this stock solution was transferred into an airtight syringe with a metal valve and subsequently removed from the glove box. In a ventilated fume hood, the Alkenyl-functional Siloxane (from 100 to 1000 g) was transferred into a Parr reactor. The reactor was sealed and loaded onto the holder. The reactor was pressurized with nitrogen up to 100 psi and was carefully relieved through a valve connected to the headspace three times. The reactor was then pressure tested by pressurizing to 200 psi with N₂. After releasing the pressure, the stock solution was added to the reactor via the septa port. The reactor was pressured with syngas to 100 psi and carefully relieved three times. It was then pressured to 100 psi, then agitation (800 rpm) and heating (70° C.) were initiated. Typical reaction times were 4-6 h. To monitor the reaction, the reactor temperature was cooled to below 60° C., the pressure was vented, and a sample was carefully drawn via the dip tube and was analyzed by ¹H NMR. Once the reaction was complete, the reactor was cooled to ambient temperature and the pressure vented. The reactor was then pressured with N₂ and released 3 times before unlocking the seal and lowering the reactor.

An amount of Raney Ni active catalyst (10-15 wt. %) was scooped out of the glass bottle while minimizing the amount of IPA taken and loaded carefully into the reactor vessel. The reactor was quickly reassembled and purged with N₂ three times. A pressure test was then performed by pressurizing the reactor to 400 psi of N₂. The reactor was pressurized with hydrogen and carefully relieved three times. It was then pressurized to 200 psi with hydrogen, and agitation (800 rpm) and heating (80° C.) were initiated. To monitor the reaction, the reactor temperature was cooled to below 60° C., the pressure was vented, and a sample was carefully drawn via the dip tube and was analyzed by ¹H NMR. Once the reaction was complete, the reactor was cooled to ambient temperature and the pressure vented. The reactor was then purged with N₂ three times before unlocking the seal and lowering the reactor. The slurry was transferred to an Erlenmeyer flask with a minimal amount of toluene. The slurry was then filtered via vacuum filtration followed by stripping of solvent using rotavap (20 Torr, 50° C.) to give a crude product. The crude product was finally pressure filtered under N₂ using a 0.2-micron PTFE filter to give a Carbinol-functional Siloxane in the form of an optically clear fluid.

### Procedure for Ethoxylation of Silicon-Bonded Carbinol Groups:

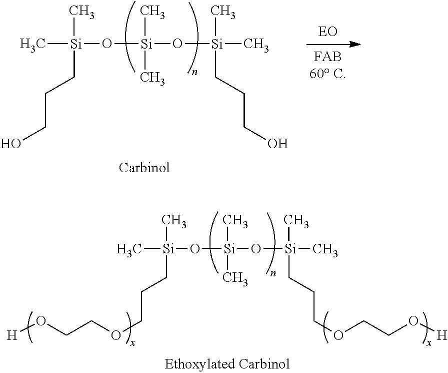

### Specific Reaction Scheme for the Ethoxylation of Polyether-Functional Siloxane

75 g of Carbinol-functional Siloxane and 0.075 g (1000 ppm) of were combined in a flask while stirring to give a solution. This solution was charged by syringe to a batch reactor under nitrogen and heated to 60° C. Ethylene oxide (44.1 g; 1.0 moL) was added to the batch reactor at a rate of 1 mL/min at 60° C. with stirring. At the end of the addition over about 1 hour, stirring at 60° C. continued for 3 more hours. Any residual ethylene oxide was purged with nitrogen, the resulting mixture was cooled, and the recovered product (106.4 g) was analyzed by ¹H NMR. The NMR test results confirmed that the recovered product was the Polyether-functional Siloxane formed via alkoxylation of the Carbinol-functional siloxane.

Table 2 below shows the Mn, Mw, and PDI of the Carbinol-functional Siloxane and the Polyether-functional Siloxane as measured via gel permeation chromatography (GPC). Specifically, the Carbinol-functional Siloxane and the Polyether-functional Siloxane were dissolved in tetrahydrofuran (THF) stabilized with 250 ppm butylated hydroxyl toluene (BHT) at a concentration of 2.0 mg/mL. Samples were shaken to dissolve solids for GPC analysis. GPC/SEC analysis was performed using an Agilent 1260 Infinity system equipped with a refractive index detector and columns with a linear MW operating range up to 30,000 g/mol. Samples (100 μL) were eluted through one PL-gel 3 μm×50×7.5 mm guard column followed by two PL-gel 3 μm×300×7.5 mm Mixed-E columns maintained at 35° C. with THF stabilized with BHT at a flowrate of 1.00 mL/min. The total run time was 23.00 min. Agilent EasiVial PS-L polystyrene standards were diluted to 1.5 mL with THF stabilized with BHT and analyzed at the same run conditions described above to create a 12-point MW calibration curve. This third order calibration curve was applied to sample results to determine MW properties.

TABLE 2
GPC analysis

| Compound: | Mn | Mw | PDI |
|---|---|---|---|
| Carbinol-functional | 1316 | 1632 | 1.24 |
| Siloxane | | | |
| Polyether-functional | 2398 | 3671 | 1.53 |
| Siloxane | | | |

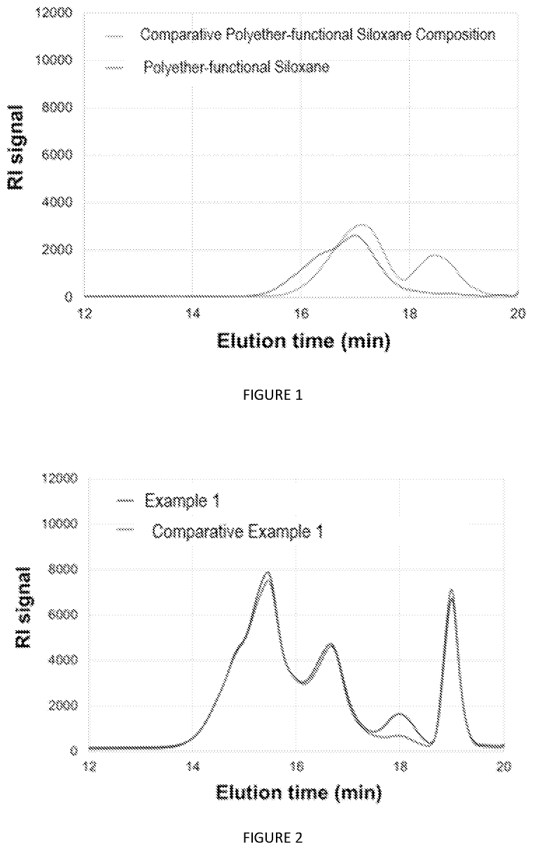

As shown in Table 2, both molecular weight and PDI increase due to ethoxylation of the Carbinol-functional Siloxane. In addition, the MW distribution of the Polyether-functional Siloxane was unimodal, whereas the MW distribution of conventional polyether-functional siloxanes prepared via hydrosilylation is bimodal. FIG. 1 shows the RI signal as a function of elution time for the Polyether-functional Siloxane and the Comparative Polyether-functional Siloxane composition.

### Example 1 and Comparative Example 1

In Example 1 and Comparative Example 1, isocyanate-functional prepolymers were prepared with the Polyether-functional Siloxane prepared above and the Comparative Polyether-functional Siloxane Composition. The Polyether-functional Siloxane was identical to the Comparative Polyether-functional Siloxane Composition but for its method of synthesis and related impurities. Specifically, as described above, the Polyether-functional Siloxane was synthesized via hydroformylation, hydrogenation (or reduction), and alkoxylation. In contrast, Comparative Polyether-functional Siloxane Composition was prepared by hydrosilylation between a siloxane having terminal dimethylhydrogensilyl groups and polyether compounds having allyl-functionality at one terminal in the presence of a platinum catalyst. As a result, the Comparative Polyether-functional Siloxane Composition includes residual amounts of the polyether compounds that were not hydrosilylated into the Polyether-functional Siloxane of the Polyether-functional Siloxane Composition, which polyether compounds cannot be easily removed therefrom. Table 3 below shows the amounts of each component utilized to prepare the isocyanate-functional prepolymers of Example 1 and Comparative Example 1. Each of the isocyanate-functional prepolymers included isocyanate-functionality at each terminal based on the particular components utilized in Example 1 and Comparative Example 1.

To prepare the isocyanate-functional prepolymers, the Polyol 1 and 2 and Polyether-functional Siloxane and Comparative Polyether-functional Siloxane Composition were dried by nitrogen purging overnight and used only when the water content was measured to be below 300 ppm. All other components were stored and used in a glove box. Reaction vessels (glass vials) were dried in an oven at 110° C. for at least 24 hours.

In Example 1 and Comparative Example 1, the isocyanate-functional prepolymers were prepared in pre-dried 30 mL glass vials in a glove box. All of the components except for the Catalyst were added to the vials and then mixed using a FlackTek Inc. Speed Mixer (Model DCV DAC 150 FVZ-K) for 60 seconds at 3000 rpm. Next, the Catalyst was added to each vial and mixed using the FlackTek for 60 seconds at 3000 rpm. The vials were taken out of glove box and then placed in an 80° C. Despatch Class A oven for 4 hours to complete the preparation of each isocyanate-functional prepolymer.

TABLE 3
Example 1 and Comparative Example 1

| Component | Example 1 | Comparative Example 1 |
|---|---|---|
| Polyol 1 (g) | 6.0 | 6.0 |
| Polyol 2 (g) | 12 | 12 |
| Polyether-functional | 6.0 | 0 |
| Siloxane (g) | | |
| Comparative Polyether- | 0 | 6.0 |
| functional Siloxane | | |
| Composition (g) | | |
| Isocyanate 1 (g) | 6.0 | 6.0 |
| Catalyst (ppm) | 1000 | 1000 |
| Benzoyl Chloride (ppm) | 1300 | 1300 |

The isocyanate-functional prepolymers prepared in Example 1 and Comparative Example 1 were analyzed via GPC. These isocyanate-functional prepolymers were first derivatized. In particular, about 0.15 g of each isocyanate-functional prepolymer was weighed into a glass vial and dissolved in 10 mL of methanol (MeOH) and tetrahydrofuran (THF) mixture (THF:MeOH=1:1 (v/v)) to give a solution. The solution was shaken until each isocyanate-functional prepolymer dissolved. Subsequently, 5 μL of a dibutyltin dilaurate catalyst solution (100 mg dibutyltin dilaurate in 1 mL THF) was added. The solutions were reacted with methanol overnight or until no isocyanate could be detected by FT-IR. Once no isocyanate was detected, the solution was diluted with THF to ˜0.2 wt. % concentration by adding 0.4 g of each solution into 12 g of THF. Each solution was filtered through a 0.45 μm PTFE syringe filter prior to injection. The molecular weights and molecular weight distributions were measured using the GPC.

GPC was performed on a Waters 2695 LC pump and autosampler. The flow rate was set at 1 mL/min, and the injection volume was set at 50 μL. The GPC separation was carried out on 2 Agilent PLgel Mixed-C columns (7.5 mm i. d.×300 mm I.) held at 35° C. The detector was a Shodex RI 201 differential refractive index detector held at 35° C.

Agilent GPC software Cirrus version 3.3 was used for data collection and data reduction. A total of 16 linear narrow molecular weight PS standards from Agilent having Mp values from 2,750 to 0.58 kg/mol were used for molecular weight calibration. A 3rd order polynomial was used for calibration curve fitting. Thus, all molecular weight averages, distributions and references to molecular weight are reported as PS equivalent values. FIG. 2 shows the RI signal as a function of elution time for the isocyanate-functional prepolymers of Example 1 and Comparative Example 1.

### Crosshatch Adhesion Testing of Example 1 and Comparative Example 1

### Preparation of Prepolymer Coatings for Crosshatch Adhesion Testing

Aluminum and glass substrates were wiped with isopropanol (IPA) using a cotton swab and air dried for 10 minutes. Then each isocyanate-functional prepolymer was coated onto the substrates using a drawdown bar to create a 6-mil (150 micro) wet coating. Coatings were allowed to cure in a humidity-controlled room (50% RH) at room temperature for about 2 weeks.

### Crosshatch Adhesion Test:

Crosshatch adhesion is used to evaluate adhesion strength of a coating to a substrate. In the crosshatch adhesion test, a crosshatch scribe is used to make parallel linear cuts through the coating. A similar set of linear cuts was made perpendicular to the original cuts in order to obtain a checkerboard pattern. A tape was applied (3M #810) to the scribed surface and rubbed with fingers in order to apply adequate pressure. The loose end of the tape was then pulled smoothly at an angle of 135° to remove the tape from the surface of each coating. The coating was then visually evaluated for adhesion and adhesion strength was measured/ranked in accordance with ASTM D3359. In case of a coating with poor adhesion to the substrate, most of the squares of the checkerboard pattern would peel off with the ASTM tape. In contrast, in case of a coating with excellent adhesion, none (or few) of the scribed squares would peel off. The adhesion was ranked from 0 to 5 with adhesion strength being directly proportional to the ranking number, as shown below in Table 4:

TABLE 4
Crosshatch adhesion rankings:

| Crosshatch adhesion ranking | Description |
|---|---|
| 5B (best) | 0% fail |
| 4B | <5% squares fail |
| 3B | 5 to 15% fail |
| 2B | 15 to 35% fail |
| 1B | 35 to 65% fail |
| 0B (worst) | >65% squares fail |

Table 5 below shows the results of the crosshatch adhesion test for the cured products of the isocyanate-functional prepolymers of Example 1 and Comparative Example 1, respectively.

TABLE 5
Crosshatch Adhesion of Cured Products from
Example 1 and Comparative Example 1:

| Substrates | Aluminum | Glass |
|---|---|---|
| Example 1 | 3.7B | 4.0B |
| Comparative Example 1 | 2.7B | 2.5B |

It is to be understood that the appended claims are not limited to express and particular compounds, compositions, or methods described in the detailed description, which may vary between particular embodiments which fall within the scope of the appended claims.

1. A composition, comprising:
(A) a carbinol-functional siloxane; and
(B) a polyisocyanate;
wherein the carbinol-functional siloxane (A) is not prepared via a hydrosilylation reaction; and
wherein the composition comprises less than 5 mole % of (C) compounds of formula R—Oₐ—(C_{b}H_{2b}O)_{c}—R¹, where R is an ethylenically unsaturated group, R¹ is H or a hydrocarbyl group, subscript a is 0 or 1, subscript b is independently selected from 2 to 4 in each moiety indicated by subscript c, and subscript c is from 0 to 500, with the proviso that subscripts a and c are not simultaneously 0.

2. The composition of claim 1, wherein:
(i) the carbinol-functional siloxane (A) comprises more than one carbinol-functional group;
(ii) the carbinol-functional group(s) have the general formula -D-Oₐ—(C_{b}H_{2b}O)_{c}—H, where D is a covalent bond or a divalent hydrocarbon linking group having from 2 to 18 carbon atoms, subscript a is 0 or 1, subscript b is independently selected from 2 to 4 in each moiety indicated by subscript c, and subscript c is from 0 to 500, with the proviso that subscripts a and c are not simultaneously 0; or
(iii) both (i) and (ii).

3. The composition of claim 1, wherein:
(i) at least one of the carbinol-functional groups has the general formula:
-D-Oₐ—[C₂H₄O]ₓ[C₃H₆O]_{y}[C₄H₈O]_{z}—H;
where D is a covalent bond or a divalent hydrocarbon linking group having from 2 to 18 carbon atoms, subscript a is 0 or 1, 0≤x≤500, 0≤y≤500, and 0≤z≤500, with the proviso that 1≤(x+y+z)≤500;
(ii) the carbinol-functional groups are pendent; or
(iii) both (i) and (ii).

4. The composition of claim 1, wherein the carbinol-functional siloxane (A) has the following general formula: 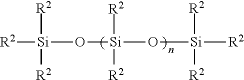
where each R² is an independently selected hydrocarbyl group or a carbinol-functional group, with the proviso that at least one R² is a carbinol-functional group, and subscript n is from 0 to 100.

5. The composition of claim 1, wherein the carbinol-functional siloxane (A) has the following general formula: 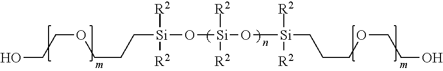
where each R² is an independently selected hydrocarbyl group, subscript n is from 0 to 100, and each of subscripts m is independently from 1 to 100.

6. The composition of claim 1, wherein the carbinol-functional siloxane (A) is formed by a process comprising:
i) forming an aldehyde-functional siloxane by a process comprising: combining, under conditions to catalyze a hydroformylation reaction, starting materials comprising
(I) a gas comprising hydrogen and carbon monoxide,
(II) an alkenyl-functional siloxane, and
(III) a rhodium/bisphosphite ligand complex catalyst;
optionally ii) recovering the aldehyde-functional siloxane;
iii) combining, under conditions to catalyze a hydrogenation reaction, starting materials comprising the aldehyde-functional siloxane, hydrogen, and a hydrogenation catalyst, thereby forming a hydrogenation reaction product comprising the carbinol-functional siloxane;
optionally iv) recovering the carbinol-functional siloxane;
optionally v) combining, under conditions to catalyze an alkoxylation reaction, starting materials comprising the carbinol-functional siloxane, an alkylene oxide, and an alkoxylation catalyst, therefrom forming a hydrogenation reaction product comprising the carbinol-functional siloxane in the form of a polyether-functional siloxane; and
optionally vi) recovering the carbinol-functional siloxane in the form of a polyether-functional siloxane.

7. The composition of claim 1, further comprising:
(D) a polyol; and optionally
(E) a catalyst.

8. A urethane prepolymer comprising the reaction product of the composition of claim 1.

9. A urethane prepolymer comprising the reaction product of the composition of claim 7.

10. The urethane prepolymer of claim 8, wherein the composition comprises a stoichiometric excess of isocyanate-functional groups in component (B) over the total amount of isocyanate-reactive groups present in the composition such that the urethane prepolymer includes at least two isocyanate-functional groups.

11. A cured product formed from the composition of claim 1.

12. A method of preparing the composition of claim 1, said method comprising:
combining (A) a carbinol-functional siloxane and (B) a polyisocyanate;
wherein the carbinol-functional siloxane (A) is not prepared via a hydrosilylation reaction; and
wherein the composition comprises less than 5 mole % of (C) compounds of formula R—Oₐ—(C_{b}H_{2b}O)_{c}—R¹, where R is an ethylenically unsaturated group, R¹ is H or a hydrocarbyl group, subscript a is 0 or 1, subscript b is independently selected from 2 to 4 in each moiety indicated by subscript c, and subscript c is from 0 to 500, with the proviso that subscripts a and c are not simultaneously 0.

13. The method of claim 12, further comprising preparing the carbinol-functional siloxane (A) by a process comprising:
i) forming an aldehyde-functional siloxane by a process comprising: combining, under conditions to catalyze a hydroformylation reaction, starting materials comprising
(I) a gas comprising hydrogen and carbon monoxide,
(II) an alkenyl-functional siloxane, and
(III) a rhodium/bisphosphite ligand complex catalyst;
optionally ii) recovering the aldehyde-functional siloxane;
iii) combining, under conditions to catalyze a hydrogenation reaction, starting materials comprising the aldehyde-functional siloxane, hydrogen, and a hydrogenation catalyst, thereby forming a hydrogenation reaction product comprising the carbinol-functional siloxane;
optionally iv) recovering the carbinol-functional siloxane;
optionally v) combining, under conditions to catalyze an alkoxylation reaction, starting materials comprising the carbinol-functional siloxane, an alkylene oxide, and an alkoxylation catalyst, therefrom forming a hydrogenation reaction product comprising the carbinol-functional siloxane in the form of a polyether-functional siloxane; and
optionally vi) recovering the carbinol-functional siloxane in the form of a polyether-functional siloxane.
